(19) United States
(12) Patent Application Publication
(10) Pub. No.: US 2025/0233245 A1
(43) Pub. Date: Jul. 17, 2025

(54) LATERAL CONSTRAINT OF BATTERY COMPONENTS UNDER FORCE

(71) Applicant: Sion Power Corporation, Tucson, AZ (US)

(72) Inventors: Jared M. Jennings, Tucson, AZ (US); Ryan Michael Niccum, Tucson, AZ (US); James Anthony Bock, Oro Valley, AZ (US); Scott Stewart, Vail, AZ (US); Joselyn Bock, Oro Valley, AZ (US); Bryce Yazzie, Marana, AZ (US)

(73) Assignee: Sion Power Corporation, Tucson, AZ (US)

(21) Appl. No.: 18/854,030

(22) PCT Filed: Apr. 6, 2023
(86) PCT No.: PCT/US2023/017689

§ 371 Date: Oct. 3, 2024

Related U.S. Application Data
(60) Provisional application No. 63/328,091, filed on Apr. 6, 2022.

(51) Int. Cl. H01M 50/242; H01M 10/04; H01M 10/653; H01M 10/658; H01M 50/204; H01M 50/249; H01M 50/289

(52) U.S. Cl. CPC H01M 50/242; H01M 10/0468; H01M 10/653; H01M 10/658; H01M 50/204; H01M 50/249; H01M 50/289

(57) ABSTRACT

Systems and methods for controlling and/or inhibiting lateral movement of battery components are generally described. Buckling of stacks of electrochemical cells can unfavorably misalign or deform battery components and may negatively impact performance of the battery. The present disclosure is directed, in some embodiments, towards inventive components that can laterally support electrochemical cells of the stack of electrochemical cells to prevent lateral motion of the electrochemical cells, thereby preventing buckling of the stack.

### RELATED APPLICATIONS

This application claims priority under 35 U.S.C. § 119(e) to U.S. Provisional Patent Application No. 63/328,091, filed Apr. 6, 2022, and entitled “LATERAL CONSTRAINT OF BATTERY COMPONENTS UNDER FORCE,” which is incorporated herein by reference in its entirety for all purposes.

### TECHNICAL FIELD

Systems and methods for controlling and/or inhibiting movement of battery components are generally described.

### BACKGROUND

Batteries typically include cells that undergo electrochemical reactions to produce electric current. Applying a force to at least a portion of an electrochemical cell (e.g., during cycling of the cell) can improve the performance of the electrochemical cell. Certain embodiments of the present disclosure are directed to inventive articles, systems, and methods relating to the handling of compressive force in batteries.

### SUMMARY

Systems and methods for controlling and/or inhibiting lateral movement of battery components are generally described. The subject matter of the present invention involves, in some cases, interrelated products, alternative solutions to a particular problem, and/or a plurality of different uses of one or more systems and/or articles.

Certain aspects are related to batteries. In some embodiments, the battery comprises a housing at least partially enclosing a first electrochemical cell; a second electrochemical cell; and a lateral support component; wherein the housing is configured to apply, during at least one period of time during charge and/or discharge of the first electrochemical cell and/or the second electrochemical cell, an anisotropic force with a component perpendicular to an electrode surface of the first electrochemical cell and/or an electrode surface of the second electrochemical cell, and the lateral support component is configured to inhibit motion of the first electrochemical cell and/or the second electrochemical cell in at least one direction having a component perpendicular to the component of the anisotropic force.

In some embodiments, the battery comprises a housing at least partially enclosing a first electrochemical cell; a second electrochemical cell; and a lateral support component; wherein the lateral support component comprises a support feature that contacts the housing and is configured to inhibit lateral motion of the first electrochemical cell and/or the second electrochemical cell.

Methods are also provided. In some embodiments, the method comprises applying, during at least one period of time during charge and/or discharge of any of the batteries described herein, an anisotropic force with a component perpendicular to an electrode surface of a first electrochemical cell of the battery and/or an electrode surface of a second electrochemical cell of the battery.

In another aspect, a battery is provided. In some embodiments, the battery, comprises: a first electrochemical cell; a second electrochemical cell; a housing comprising a solid plate, a housing stop portion adjacent to an exterior surface of the solid plate, and a solid housing component; wherein: the housing at least partially encloses the first electrochemical cell and the second electrochemical cell the solid plate is configured to apply, during at least one period of time during charge and/or discharge of the first electrochemical cell and/or the second electrochemical cell, an anisotropic force with a component perpendicular to an electrode surface of the first electrochemical cell and/or an electrode surface of the second electrochemical cell; the solid housing component is coupled to the solid plate via coupling to the housing stop portion; and the housing stop portion is configured to be anchored to a body external to the battery via a fastener.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a cross-sectional schematic diagram of a battery comprising electrochemical cells, a lateral support component, and a housing, according to some embodiments;

FIG. 1B shows a cross-sectional schematic diagram of a battery comprising electrochemical cells, a lateral support component, and a housing, according to some embodiments;

FIG. 2 shows a cross-sectional schematic diagram of an electrochemical cell, according to some embodiments;

FIG. 3A shows a cross-sectional schematic diagram of a battery comprising a stack comprising electrochemical cells, and a housing that comprises a solid plate, a solid housing component, and a housing stop portion, according to some embodiments;

FIG. 3B shows an exploded perspective view schematic diagram of a battery comprising a stack comprising electrochemical cells, and a housing that comprises a solid plate, a solid housing component, and a housing stop portion, according to some embodiments;

FIG. 3C shows a perspective view schematic diagram of a battery comprising a stack comprising electrochemical cells, and a housing that comprises a solid plate, a solid housing component, and a housing stop portion, according to some embodiments;

FIG. 3D shows a perspective view schematic diagram of a battery comprising a stack comprising electrochemical cells, and a housing that comprises a solid plate, a solid housing component, and a housing stop portion, according to some embodiments;

FIG. 4 shows a top view schematic diagram of a lateral support component, according to some embodiments;

FIG. 5 presents a perspective view schematic illustration of a lateral support component, according to some embodiments;

FIG. 6A shows a perspective view schematic diagram of a lateral support component, according to some embodiments;

FIG. 6B shows a perspective view schematic diagram of an end plate, according to some embodiments;

FIG. 7 shows a cross-sectional schematic diagram of a lateral support component inside a battery, according to some embodiments;

FIG. 8 shows a top view schematic diagram of a lateral support component inside a battery, according to some embodiments;

FIG. 9A shows a perspective view schematic diagram of a lateral support component, according to some embodiments;

FIG. 9B shows a perspective view schematic diagram of a lateral support component, according to some embodiments;

FIG. 10A shows a perspective view schematic diagram of lateral bracing, according to some embodiments;

FIG. 10B shows a perspective view schematic diagram of lateral bracing, according to some embodiments;

FIG. 11A shows a perspective view schematic diagram of lateral bracing, according to some embodiments;

FIG. 11B shows a perspective view schematic diagram of lateral bracing, according to some embodiments;

FIG. 12 shows a perspective view schematic diagram of lateral bracing, according to some embodiments;

FIG. 13 shows a perspective view schematic illustrations of a battery pack comprising a housing comprising a frame, a solid plate, and stop portions, according to some embodiments.

FIG. 14 shows a cross-sectional schematic diagram of a battery comprising a stack comprising electrochemical cells, and a housing that comprises a solid plate and a solid housing component, according to some embodiments;

FIG. 15A shows a cross-sectional schematic diagram of a battery comprising a stack comprising electrochemical cells, and a housing that comprises a solid plate, a solid housing component, and a housing stop portion, according to some embodiments;

FIG. 15B shows an exploded perspective view schematic diagram of a battery comprising a stack comprising electrochemical cells, and a housing that comprises a solid plate, a solid housing component, and a housing stop portion, according to some embodiments;

FIG. 15C shows a perspective view schematic diagram of a battery comprising a stack comprising electrochemical cells, and a housing that comprises a solid plate, a solid housing component, and a housing stop portion, according to some embodiments;

FIG. 15D shows a perspective view schematic diagram of a battery comprising a stack comprising electrochemical cells, and a housing that comprises a solid plate, a solid housing component, and a housing stop portion, according to some embodiments;

FIG. 15E shows a perspective view schematic diagram of a battery comprising a stack comprising electrochemical cells, and a housing that comprises a solid plate, a solid housing component, and a housing stop portion anchored to an external body, according to some embodiments;

FIG. 16 shows a cross-sectional schematic diagram of a battery comprising electrochemical cells, a thermally conductive solid article portion, a lateral support component, and a thermally insulating compressible solid article portion, according to some embodiments;

FIGS. 17A-17B show cross-sectional schematic diagrams of stacks comprising electrochemical cells, a lateral support component, and a thermally insulating compressible solid article portion, according to some embodiments;

FIG. 18 shows a cross-sectional schematic diagram of a battery comprising electrochemical cells and lateral support components comprising alignment features, according to some embodiments;

FIG. 19 shows a perspective view schematic diagram of a lateral support component comprising an alignment feature and a non-planarity, according to some embodiments;

FIG. 20 shows a cross-sectional schematic diagram of an electrochemical cell, according to some embodiments;

FIG. 21 shows a cross sectional schematic diagram of an electric vehicle comprising a battery, according to some embodiments;

FIG. 22A shows a perspective view schematic illustration of a battery pack comprising a housing comprising a frame, a solid plate, stop portions, and inserts, as well as a substrate, electronically conductive interconnects, electrochemical cells, thermally insulating compressible solid article portions, and terminals, shown without a cover, according to some embodiments;

FIG. 22B shows an exploded schematic illustration of the components of the battery pack of FIG. 13, according to some embodiments;

FIG. 22C shows a perspective view schematic illustration of a cover for a battery pack, according to some embodiments;

FIG. 22D shows a perspective view schematic illustration of a lateral support component, according to some embodiments;

FIG. 23A shows a perspective view schematic illustration of a battery pack comprising a housing comprising a frame, a solid plate, stop portions, and inserts, as well as a substrate, electronically conductive interconnects, electrochemical cells, thermally insulating compressible solid article portions, and terminals, shown without a cover, according to some embodiments;

FIG. 23B shows an exploded schematic illustration of the components of the battery pack of FIG. 23A, according to some embodiments;

FIG. 23C shows a perspective view schematic illustration of a cover for a battery pack, according to some embodiments;

FIG. 23D shows a front perspective view schematic illustration of a lateral support component, according to some embodiments; and

FIG. 23E shows a back perspective view schematic illustration of a cover for a battery pack, according to some embodiments.

### DETAILED DESCRIPTION

Systems and methods for controlling and/or inhibiting lateral movement of battery components are generally described. The systems and methods described herein can be used, for example, in batteries in which the electrochemical cells are under an applied anisotropic force.

A number of advantages may result from the application of anisotropic force to a stack of electrochemical cells within the battery. However, in some embodiments, applying anisotropic force to the stack of electrochemical cells can cause the stack of electrochemical cells to buckle or otherwise shift laterally. Buckling of stacks of electrochemical cells can unfavorably misalign or deform battery components, may cause non-uniformity of force acting on the electrochemical cells, and may negatively impact performance of the battery. The present disclosure is directed, in some embodiments, to components that can laterally support electrochemical cells of the stack of electrochemical cells to prevent lateral motion of the electrochemical cells, thereby preventing buckling of (or other lateral shifting of cells within) the stack.

In some cases, it may be beneficial to apply force to electrochemical cells in a battery. For example, in some cases applying an anisotropic force with a component perpendicular to at least one electrode surface of the electrochemical cells can improve performance during charging and/or discharging by reducing problems such as dendrite formation and surface roughening of the electrode while improving current density. One such example is the case where at least one of the electrochemical cells of the battery comprises lithium metal or a lithium metal alloy as an electrode active material. Lithium metal may undergo dendrite growth during cell cycling (e.g., during replating during charging), for example, which can in certain cases lead to failure of the electrochemical cell and safety hazards. Application of relatively high magnitudes of anisotropic force to electrodes comprising lithium metal may mitigate lithium dendrite formation and other deleterious phenomena. However, it has been realized in the context of the present disclosure that numerous challenges may emerge when applying force within batteries comprising multiple electrochemical cells (e.g., comprising lithium and/or lithium alloy as an electrode active material). For example, application of a relatively uniform force such that each of the electrochemical cells experiences a relatively similar pressure distribution can be important for performance and/or durability, and managing pressure on multiple cells must be accomplished simultaneously.

In some instances, it has been observed that application of such an anisotropic force to one or more electrochemical cells of a battery can cause a tendency for battery components (e.g., in a stack) to undergo buckling and/or lateral misalignment. Buckling and/or lateral misalignment of battery components (e.g., electrochemical cells and battery components between electrochemical cells) may act as sources of non-uniformity in the force experienced by electrochemical cells. Moreover, in a battery comprising a stack of multiple electrochemical cells, the nonuniformity of force experienced by the electrochemical cells as a result of buckling and/or lateral misalignment may be amplified as a result of cumulative irregularities in components of the stack. In a variety of aspects, this disclosure provides articles, methods, and systems for the inhibition of lateral movement (e.g., via physical constraint) of battery components under applied forces.

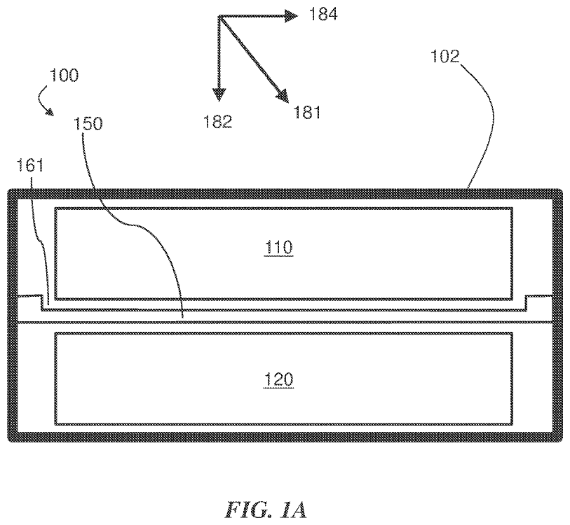

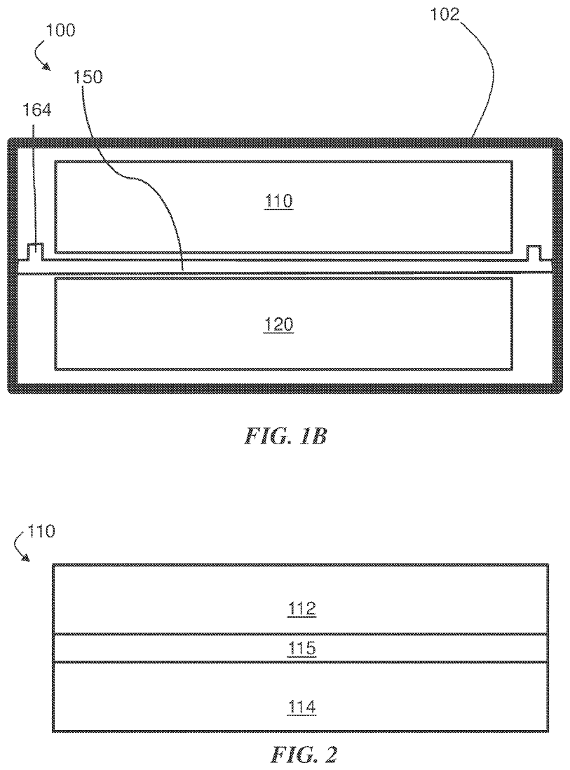

In one aspect, batteries are generally described. Generally, a battery comprises a first electrochemical cell and a second electrochemical cell. In some embodiments, the battery comprises one or more rechargeable lithium-ion electrochemical cells. In some embodiments, one or more electrochemical cells of the battery are at least partially enclosed by a housing. For example, FIGS. 1A-1B are cross-sectional schematic diagrams of non-limiting embodiments of batteries 100 comprising multiple electrochemical cells. Battery 100 in FIG. 1A comprises first electrochemical cell 110 and second electrochemical cell 120 at least partially enclosed by housing 102. The battery may additionally comprise one or more other components (e.g., lateral support components, articles stacked with the electrochemical cells, housings, electrical and thermal management equipment) described in greater detail below.

In some embodiments, the battery comprises a component that is configured to inhibit lateral movement (e.g., buckling) of cells within a stack of electrochemical cells of the battery. For example, the battery may comprise a lateral support component, as described in greater detail below. Battery 100 of FIG. 1A comprises lateral support component 150, for example. In some embodiments, the lateral support component is configured to inhibit motion of the first electrochemical cell and/or the second electrochemical cell, as described in greater detail below. In some embodiments, at least one electrochemical cell of the battery (e.g., first electrochemical cell, second electrochemical cell) comprises lithium metal and/or a lithium metal alloy as an electrode active material.

In some embodiments, electrochemical cells in the battery (e.g., the first electrochemical cell, the second electrochemical cell) comprise at least one anode. FIG. 2 shows a schematic diagram of one embodiment of first electrochemical cell 110 comprising anode 112. In some cases, the anode comprises an anode active material. As used herein, an “anode active material” refers to any electrochemically active species associated with an anode. In some embodiments, the anode comprises lithium metal and/or a lithium metal alloy as an anode active material. For example, referring again to FIG. 2, anode 112 comprises lithium metal and/or a lithium metal alloy as an anode active material in some embodiments. An electrode such as an anode can comprise, in accordance with certain embodiments, lithium metal and/or a lithium metal alloy as an electrode active material during at least a portion of or during all of a charging and/or discharging process of the electrochemical cell. In certain cases, the anode is or comprises vapor-deposited lithium (e.g., a vapor-deposited lithium film). Additional suitable anode active materials are described in more detail below. Certain embodiments described herein may be directed to systems, devices, and methods that may allow for improved performance (e.g., magnitude and/or uniformity of applied force, alignment of electrochemical active regions to promote uniformity of lithium deposition during charging) of electrochemical cells comprising certain anodes, such as lithium metal-containing anodes.

In some embodiments, electrochemical cells in the battery (e.g., the first electrochemical cell, the second electrochemical cell) comprise at least one cathode. For example, referring again to FIG. 2, first electrochemical cell 110 comprises cathode 114. The cathode can comprise a cathode active material. As used herein, a “cathode active material” refers to any electrochemically active species associated with a cathode. In certain cases, the cathode active material may be or comprise a lithium intercalation compound (e.g., a metal oxide lithium intercalation compound). As one non-limiting example, in some embodiments, cathode 114 in FIG. 2 comprises a nickel-cobalt-manganese lithium intercalation compound. Additional examples of suitable cathode active materials are described in more detail below.

As used herein, “cathode” refers to the electrode in which an electrode active material is oxidized during charging and reduced during discharging, and “anode” refers to the electrode in which an electrode active material is reduced during charging and oxidized during discharging.

In some embodiments, electrochemical cells in the battery (e.g., the first electrochemical cell, the second electrochemical cell) comprise a separator between the anode and the cathode. FIG. 2 shows, as a non-limiting example, separator 115 between anode 112 and cathode 114. The separator may be a solid electronically non-conductive or insulative material that separates or insulates the anode and the cathode from each other, preventing short circuiting, and that permits the transport of ions between the anode and the cathode. In some embodiments, the separator is porous and may be permeable to an electrolyte.

It should be understood that while in some embodiments the first electrochemical cell and the second electrochemical cell have the same types of components (e.g., same anode active material, same cathode active material, same type of separator), in other embodiments the first electrochemical cell has one or more different components than the second electrochemical cell (e.g., a different anode active material, a different cathode active material, a different type of separator). In some embodiments, the first electrochemical cell and the second electrochemical cell are identical in composition and/or dimensions.

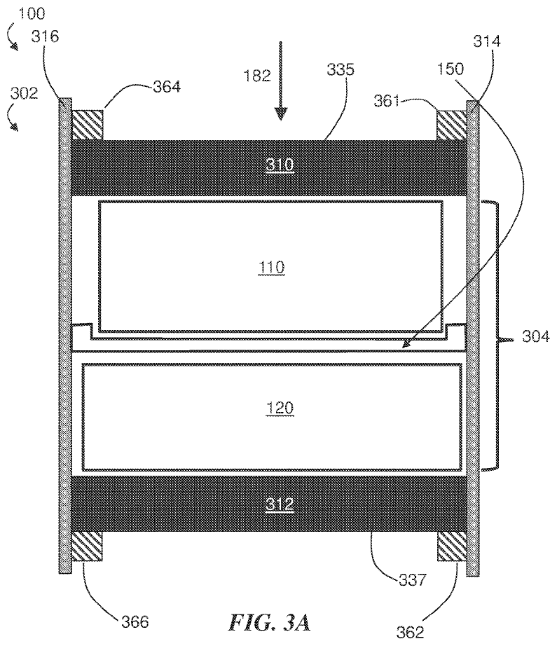

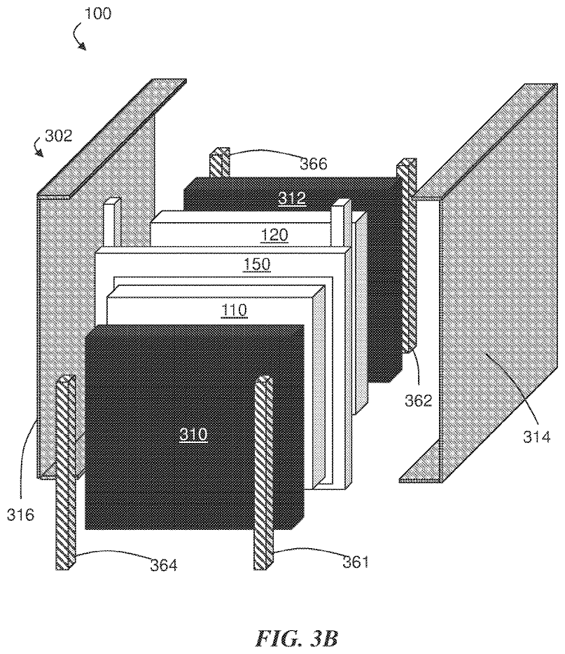

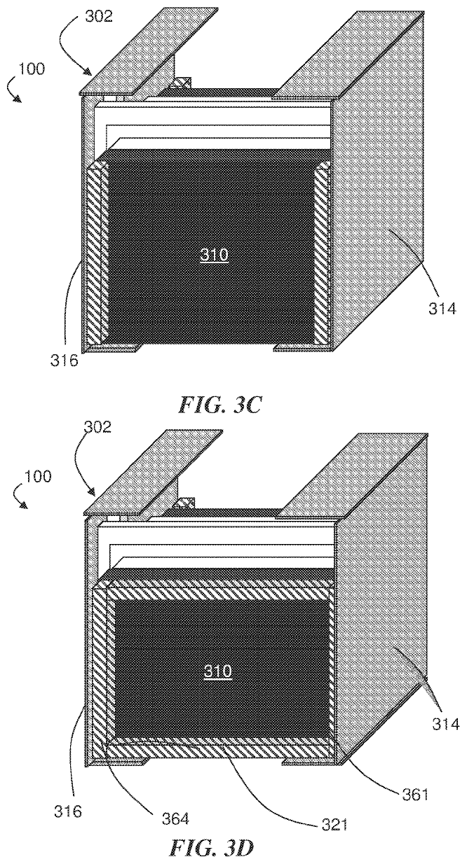

In some embodiments, the battery comprises a housing. The housing may at least partially enclose other components of the battery. For example, the housing may at least partially enclose the first electrochemical cell and the second electrochemical cell. FIG. 1A shows housing 102 at least partially enclosing first electrochemical cell 110 and second electrochemical cell 120, according to certain embodiments. The housing may comprise rigid components. As one example, the housing may comprise one or more solid plates. The solid plate may, for example, be an endplate. FIGS. 3A-3D show schematic diagrams of a non-limiting example of battery 100 comprising housing 302 comprising first solid plate 310 and second solid plate 312. (These figures are elaborated upon in greater detail below.) In certain cases, the housing does not comprise a solid plate. For example, in some cases, the solid surface and other components of a containment structure of a housing configured to house the electrochemical cells are part of a unitary structure.

Some embodiments are related to applying, during at least one period of time during charge and/or discharge of the electrochemical cells (e.g., first electrochemical cell, second electrochemical cell), an anisotropic force with a component perpendicular to an electrode surface of at least one electrochemical cell of the battery. As mentioned above, application of such a force may reduce potentially deleterious phenomena associated with certain types of electrochemical cells (e.g., cells comprising lithium metal as an electrode active material) and improve utilization. For example, in some cases, applying an anisotropic force with a component perpendicular to an electrode surface of an electrode of the electrochemical device can reduce problems (such as surface roughening of the electrode and dendrite formation) while improving current density. Application of such forces to multiple electrochemical cells of a battery pack may present certain challenges, including uniformity of pressure distribution for each electrochemical cell, which can be important for both performance and durability. Certain aspects described herein may, in some cases, address and overcome such challenges.

FIG. 1A depicts a schematic cross-sectional illustration of a force that may be applied to the first electrochemical cell and the second electrochemical cell in the direction of arrow 181. Arrow 182 illustrates the component of force 181 that is perpendicular to top electrode surface of first electrochemical cell 110, according to certain embodiments. In some embodiments, the electrode surface to which the component is perpendicular is a major surface of the electrode (i.e., a surface having, at its edges, the two largest dimensions of the electrode). The electrode surface to which the component is perpendicular may, in accordance with certain embodiments, be an electrode active surface. As used herein, the term “electrode active surface” is used to describe a surface of an electrode at which electrochemical reactions may take place. As one example, in embodiments in which the electrode comprises a lithium metal foil as the anode active material, the external surface of the lithium metal foil would be an active surface of the electrode. In general, the electrode active surface can be in physical contact with an electrolyte when the electrode is part of an electrochemical cell, such that the electrolyte transports ions or other non-electron electrochemically active reactants between that electrode and a counter-electrode.

In some embodiments, the housing of the battery is configured to apply, during at least one period of time during charge and/or discharge of the first electrochemical cell and/or the second electrochemical cell, an anisotropic force having a relatively high-magnitude component perpendicular to (i.e., normal to) electrode surfaces of at least one (or all) of the electrochemical cells in the battery. For example, in some embodiments where the battery comprises a first electrochemical cell having a first electrode surface and a second electrochemical cell having a second electrode surface, the housing of the battery is configured to apply, during at least one period of time during charge and/or discharge of the first electrochemical cell and/or the second electrochemical cell, an anisotropic force having a relatively high-magnitude component perpendicular to the first electrode surface and the second electrode surface. The housing may be configured to apply such a force in a variety of ways. For example, in some embodiments, the housing comprises two solid articles (e.g., a first solid plate and a second solid plate as shown in FIG. 3A, where housing 302 comprises first solid plate 310 and second solid plate 312). An object (e.g., a machine screw, a nut, a spring, etc.) may be used to apply the force by applying pressure to the ends (or regions near the ends) of the housing. In the case of a machine screw, for example, the electrochemical cells and other components of the battery may be compressed between the plates (e.g., a first solid plate and a second solid plate) upon rotating the screw. As another example, in some embodiments, one or more wedges may be displaced between the housing and a fixed surface (e.g., a tabletop, etc.). The force may be applied by driving the wedge between the housing (e.g., between a solid plate of a containment structure of the housing) and the adjacent fixed surface through the application of force on the wedge (e.g., by turning a machine screw).

Some embodiments comprise applying an anisotropic force with a component perpendicular to a first electrode surface (e.g., an electrode active surface) of the first electrochemical cell and/or a second electrode surface (e.g., an electrode active surface) of the second electrochemical cell, where the component defines a pressure of at least at least 3 kg_{f}/cm², at least 5 kg_{f}/cm², 10 kg_{f}/cm², at least 12 kg_{f}/cm², at least 20 kg_{f}/cm², and/or up 25 kg_{f}/cm², or more. In some such cases, the housing is configured to apply such anisotropic forces. While high magnitudes of anisotropic force with a component perpendicular to an electrode surface can improve performance, too high of a magnitude of force may cause problems such as damage to certain components of the battery (e.g., the thermally insulating compressible solid article portion described below). It has been observed, however, that there are ranges of magnitudes of anisotropic force that can be applied that can, in some cases, achieve desirable performance of the battery while avoiding such damage. For example, some embodiments comprise applying (e.g., via the housing) during at least one period of time during charge and/or discharge of the first electrochemical cell and/or the second electrochemical cell, an anisotropic force with a component perpendicular to a first electrode surface of the first electrochemical cell and/or a second electrode surface of the second electrochemical cell defining a pressure of less than or equal to 40 kg_{f}/cm², less than or equal to 35 kg_{f}/cm², less than or equal to 30 kg_{f}/cm², less than or equal to 25 kg_{f}/cm², or less. Combinations of these ranges (e.g., at least 10 kg_{f}/cm² and less than or equal to 40 kg_{f}/cm², at least 10 kg_{f}/cm² and less than or equal to 25 kg_{f}/cm², or at least 12 kg_{f}/cm² and less than or equal to 30 kg_{f}/cm²) are possible. In some embodiments, an anisotropic force with a component perpendicular to a first electrode active surface of the first electrochemical cell and/or a second active electrode surface the second electrochemical cell defining a pressure in one of the aforementioned ranges is applied. In some embodiments, an anisotropic force with a component perpendicular to a surface an electrode of the first electrochemical cell and/or a surface of an electrode of the second electrochemical cell defining a pressure in one of the aforementioned ranges is applied, where the electrode of the first electrochemical cell and/or the second electrochemical cell comprises metallic lithium (e.g., lithium metal and/or a metal alloy comprising lithium). In some embodiments, an anisotropic force with a component perpendicular to a surface of an electrode of the first electrochemical cell and/or a surface of an electrode of the second electrochemical cell defining a pressure in one of the aforementioned ranges is applied, where the surface of the electrode of the first electrochemical cell and/or the second electrochemical cell is facing an electrode of the first electrochemical cell or the second electrochemical cell having an opposite polarity (e.g., the anisotropic force has a component perpendicular to a surface of an anode facing a cathode of the cell, or the anisotropic force has a component perpendicular to a surface of a cathode facing an anode of the cell).

As used herein, a surface is said to be “facing” an object when a line extending perpendicular to that surface and away from the bulk of the material comprising the surface intersects the object. For example, a first surface and a second surface can be facing each other if a line perpendicular to the first surface and extending away from the bulk of the material comprising the first surface intersects the second surface. A surface can be facing another object when it is in contact with the other object, or when one or more intermediate materials are positioned between the surface and the other object. For example, two surfaces that are facing each other can be in contact or can include one or more intermediate materials between them. In some instances, a surface and an object (e.g., another surface) facing each other are substantially parallel. In some embodiments, two surfaces can be substantially parallel if, for example, the maximum angle defined by the two planes is less than or equal to 20°, less than or equal to 10°, less than or equal to 5°, or less than or equal to 2°.

In some embodiments where the first electrochemical cell and the second electrochemical cell are part of a stack of cells, an anisotropic force with a component perpendicular to a lateral surface of the stack (corresponding to an end of the stack rather than a side of the stack) defining a pressure in one of the aforementioned ranges is applied. In some embodiments where the first electrochemical cell and the second electrochemical cell are part of a stack of cells, an anisotropic force with a component substantially parallel to the direction in which the cells are stacked defining a pressure in one of the aforementioned ranges is applied. For example, in FIG. 3A, force 182 is substantially parallel to the direction in which stack 304 comprising first electrochemical cell 110 and second electrochemical cell 120 is stacked and can define a pressure in one of the aforementioned ranges. In this context (and in all other contexts herein in which the term is used), “substantially parallel” can be within 20°, within 10°, within 5°, or within 2° of parallel, in some embodiments.

In some embodiments, the magnitude of anisotropic force defines a pressure of 10-15 kg_{f}/cm² at a 0% SOC and 25-35 kg_{f}/cm² at a 100% SOC. In one example of an embodiment, the magnitude of anisotropic force defines a pressure of 12 kg_{f}/cm² at a 0% SOC and 30 kg_{f}/cm² at a 100% SOC.

Some embodiments comprise applying an external anisotropic force to a stack at least partially enclosed by a housing described above (e.g., with one or more solid housing components), the stack comprising a first electrochemical cell and a second electrochemical cell. As mentioned above, the external anisotropic force may have a component perpendicular to a first electrode surface of the first electrochemical cell and/or a second electrode surface of the second electrochemical cell. The external anisotropic force may be applied via a pressure application device/system external to the battery (e.g., an external clamp, a hydraulic press, etc.), and may be applied, for example, during manufacture of a battery comprising the stack and the housing. The external anisotropic force may define a pressure of at least 3 kg_{f}/cm², at least 5 kg_{f}/cm², at least 10 kg_{f}/cm², at least 12 kg_{f}/cm², at least 20 kg_{f}/cm², and/or up to 25 kg_{f}/cm², up to 30 kg_{f}/cm², up to 35 kg_{f}/cm², up to 40 kg_{f}/cm², or more. Some embodiments of such housings are described above. In some embodiments, an anisotropic force with a component perpendicular to a first electrode active surface of the first electrochemical cell and/or a second active electrode surface the second electrochemical cell defining a pressure in one of the aforementioned ranges is applied. In some embodiments, an anisotropic force with a component perpendicular to a surface of an electrode of the first electrochemical cell and/or a surface of an electrode of the second electrochemical cell defining a pressure in one of the aforementioned ranges is applied, where the electrode of the first electrochemical cell and/or the second electrochemical cell comprises metallic lithium (e.g., lithium metal and/or a metal alloy comprising lithium). In some embodiments, an anisotropic force with a component perpendicular to a surface of an electrode of the first electrochemical cell and/or a surface of an electrode of the second electrochemical cell defining a pressure in one of the aforementioned ranges is applied, where the surface of the electrode of the first electrochemical cell and/or the second electrochemical cell is facing an electrode of the first electrochemical cell or the second electrochemical cell having an opposite polarity (e.g., the anisotropic force has a component perpendicular to a surface of an anode facing a cathode of the cell, or the anisotropic force has a component perpendicular to a surface of a cathode facing an anode of the cell). In some embodiments where the first electrochemical cell and the second electrochemical cell are part of a stack of cells, an anisotropic force with a component perpendicular to a lateral surface of the stack (corresponding to an end of the stack rather than a side of the stack) defining a pressure in one of the aforementioned ranges is applied. In some embodiments where the first electrochemical cell and the second electrochemical cell are part of a stack of cells, an anisotropic force with a component substantially parallel to the direction in which the cells are stacked defining a pressure in one of the aforementioned ranges is applied. For example, in FIG. 3A, force 182 is substantially parallel to the direction in which stack 304 comprising first electrochemical cell 110 and second electrochemical cell 120 is stacked and can define a pressure in one of the aforementioned ranges.

As described above, in some embodiments, a force, or forces, is applied to portions of an electrochemical cell. Such application of force may reduce irregularity or roughening of an electrode surface of the cell (e.g., when lithium metal or lithium alloy anodes are employed), thereby improving performance. Electrochemical devices in which anisotropic forces are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

In the embodiments described herein, batteries may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with certain embodiments described herein, to reduce such behavior and to improve the cycling lifetime and/or performance of the cell.

In some embodiments, the battery (e.g., a housing of the battery) is configured to apply, during at least one period of time during charge and/or discharge of the device, an anisotropic force with a component perpendicular to an electrode surface of one of the electrochemical cells (e.g., first electrochemical cell, second electrochemical cell).

In some embodiments, an anisotropic force with a component perpendicular to an electrode surface of one of the electrochemical cells (e.g., first electrochemical cell, second electrochemical cell) is applied during at least one period of time during charge and/or discharge of the battery. In some embodiments, the force may be applied continuously, over one period of time, or over multiple periods of time that may vary in duration and/or frequency. The anisotropic force may be applied, in some cases, at one or more pre-determined locations, optionally distributed over an electrode surface of the one or more of the electrochemical cells of the battery. In some embodiments, the anisotropic force is applied uniformly over one or more electrode surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component perpendicular” to a surface, for example an electrode surface of an electrode such as an anode, is given its ordinary meaning as would be understood by those of ordinary skill in the art and includes, for example, a force which, at least in part, exerts itself in a direction substantially perpendicular to the surface. As used herein, the word “normal” is used interchangeably with the word “perpendicular”.

In some embodiments, the anisotropic force can be applied such that the magnitude of the force is substantially equal in all directions within a plane defining a cross-section of the battery, but the magnitude of the forces in out-of-plane directions is substantially unequal to the magnitudes of the in-plane forces.

In one set of embodiments, batteries (e.g., housings) described herein are configured to apply, during at least one period of time during charge and/or discharge of the cell, an anisotropic force with a component perpendicular to an electrode surface of one of the electrochemical cells (e.g., first electrochemical cell, second electrochemical cell). In such an arrangement, the electrochemical cell may be formed as part of a container which applies such a force by virtue of a “load” applied during or after assembly of the cell, or applied during use of the battery as a result of expansion and/or contraction of one or more components of the battery itself.

In some cases, one or more forces applied to the cell have a component that is not perpendicular to an electrode surface of an anode. For example, in FIG. 1A force component 184 is not perpendicular to electrode surfaces of the first electrochemical cell 110 and second electrochemical cell 120. In one set of embodiments, the sum of the components of all applied anisotropic forces in a direction perpendicular to any electrode surface of the battery is larger than any sum of components in a direction that is not perpendicular to the electrode surface. In some embodiments, the sum of the components of all applied anisotropic forces in a direction perpendicular to any electrode surface of the battery is at least 5%, at least 10%, at least 20%, at least 35%, at least 50%, at least 75%, at least 90%, at least 95%, at least 99%, or at least 99.9% larger than any sum of components in a direction that is parallel to the electrode surface.

In the context of the present disclosure it has been recognized that without lateral support, a stack of electrochemical cells may be prone to movement in a lateral dimension of the stack (e.g., buckling). Lateral movement of cells within a stack may be detrimental to stack performance, and may cause issues such as misalignment of electrochemical cells, non-uniform lateral force distributions, etc. Without wishing to be bound by theory, buckling and other forms of lateral movement of cells within the stack may result from eccentricity in the anisotropic force applied to the stack of electrochemical cells, resulting in a tendency of stack components (e.g., electrochemical cells) to be pushed in one or more directions having a component perpendicular to a component of applied anisotropic force that is perpendicular to an electrode surface.

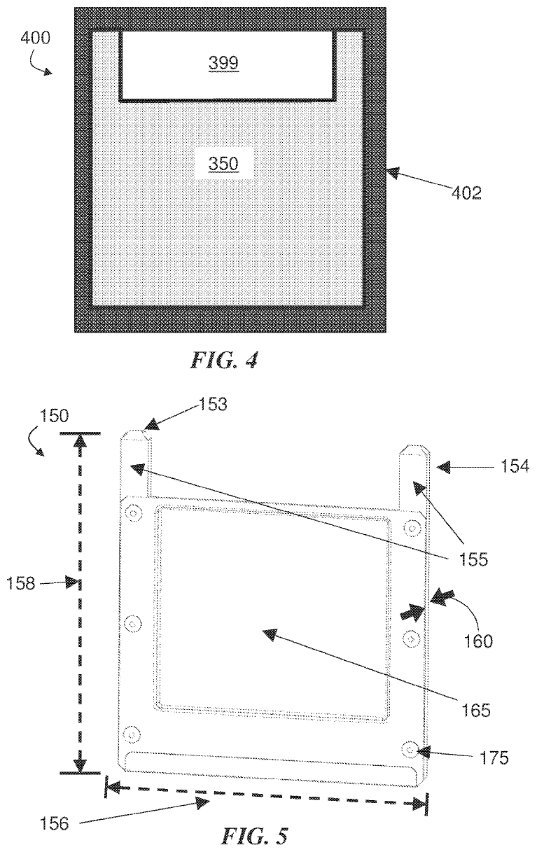

According to certain aspects, the battery comprises a lateral support component. The lateral support component may be configured to reinforce the stack against movement of at least one cell of the stack in a lateral dimension (e.g., at least one direction having a component perpendicular to a component of anisotropic force that is perpendicular to an electrode surface. For example, the lateral support component may be configured to support the stack of electrochemical cells against a housing at least partially enclosing the stack of electrochemical cells. For example, FIG. 4, presents a cross-sectional schematic illustration of battery 400, which comprises lateral support component 350 and housing 402. Lateral support component 350 is braced against housing 402, thereby inhibiting lateral motion of lateral support component 350 and any cells associated with lateral support component 350.

Generally, the lateral support component comprises a solid body. As used here, the phrase “solid body” is used to refer to elements that include a solid component. Solid bodies may, in certain cases, include cavities and/or be hollow, as long as other portions of the solid body are made of solid material. In other embodiments, the solid body can be free of cavities.

In some embodiments, the solid body of the lateral support component interfaces with an interior boundary of the housing of the battery. The solid body may interface with the interior boundary of the housing such that lateral movement of one or more electrochemical cells associated with the lateral support component is inhibited (e.g., prevented or reduced, relative to the lateral movement that would be present in the absence of the lateral support component but under otherwise identical conditions). The lateral support component may comprise one, two, or more solid bodies that independently interface with the interior boundary of the housing. The lateral support component may be configured to inhibit (e.g., prevent) motion of an electrochemical cell (e.g., a first electrochemical cell a second electrochemical cell) in a direction that is substantially perpendicular or otherwise not substantially parallel to a component of applied anisotropic force perpendicular to an electrode surface (e.g., lateral motion). Two directions (e.g., a direction of motion and a direction of an anisotropic force component) can be substantially perpendicular if, for example, an angle between the two directions is within ±20°, ±10°, ±5°, or ±2° of a 90° angle (i.e. if the angle between the two directions is between 70° and 110°, between 80° and 100°, between 85° and 95°, or between 88° and) 92°.

The lateral support component is generally configured to interface with an electrochemical cell. The lateral support component may interface with the electrochemical cell directly or indirectly. An electrochemical cell may be coupled to a non-planarity (e.g., a recess) in a lateral support component by having a shape such that the at least a portion of the electrochemical cell can fit into the non-planarity. For example, referring again to FIG. 1A, first electrochemical cell 110 fits into non-planarity 161 like an object in a pocket, such that when first electrochemical cell 110 and lateral support component 150 are coupled, the position of first electrochemical cell 110 is fixed with respect to lateral support component 150. It should be understood that while FIG. 1A shows an entirety of the illustrated first electrochemical cell 110 fitting into non-planarity 161, in some embodiments one or more portions of an electrochemical cell, such as a conductive tab or pouch, may not be fit into the non-planarity, and may extend past the lateral support component. In some embodiments in which the electrochemical cell comprises a pouch, a portion of the pouch extending past the electrode active surfaces of the electrochemical cell is folded. Folding portions of the pouch may reduce the lateral dimension of the electrochemical cell, which may allow for an overall smaller housing to be used for the battery pack (which can increase the volumetric energy density of the battery pack).

In some embodiments, the non-planarity of a lateral support component of the battery pack is a raised portion (e.g., raised in a thickness direction, relative to surrounding material of the lateral support component). The raised portion may extend away from the main surface of the lateral support component facing the electrochemical cell. For example, FIG. 1B shows a cross-sectional schematic diagram of battery 100 comprising first electrochemical cell 110 coupled to non-planarity 164 of lateral support component 150. In FIG. 1B, non-planarity 164 is a raised portion from lateral support component 150.

An electrochemical cell may be coupled to a raised portion of a lateral support component by having a shape such that the electrochemical cell can fit between raised portions. For example, referring again to FIG. 1B, first electrochemical cell 110 couples to non-planarity 164 by fitting between the raised portions of non-planarity 164 such that the position of first electrochemical cell 110 is fixed with respect to lateral support component 150. It should be understood that while FIG. 1B shows an entirety of the illustrated first electrochemical cell 110 fitting between raised portions of non-planarity 164, in some embodiments one or more portions of an electrochemical cell, such as a conductive tab or pouch, may not be fit into or between portions of the non-planarity, and may extend past the lateral support component.

A non-planarity that is a raised portion may take any of a variety of forms. For example, in some embodiments, a non-planarity that is a raised portion is a raised edge, a ridge, or a plurality of posts extending from the lateral support component.

Non-planarities in lateral support components (e.g., recesses, raised portions) may be formed in any of a variety of suitable ways, such as via machining, milling, molding, additive manufacturing (e.g., 3D-printing), etc.

The lateral support component may be configured to inhibit motion of the electrochemical cell in a direction substantially parallel to the electrode surface (e.g., a major surface of the electrode), such as an electrode active surface. For example, the lateral support component may be configured to prevent motion of the electrochemical cell in a direction substantially parallel to the electrode surface, such as an electrode active surface. A direction can be substantially parallel to a surface if, for example, a minimum angle between the direction and the surface is less than or equal to 20°, less than or equal to 10°, less than or equal to 5°, or less than or equal to 2°. A direction substantially parallel to the electrode surface may be a lateral direction of the battery.

The lateral support component may have any of a variety appropriate forms or geometries. In some embodiments, the lateral support component has wide lateral dimensions relative to its thickness. For example, FIG. 5 presents a non-limiting example of a lateral support component that has lateral dimensions 156 and 158 which are greater than thickness 160.

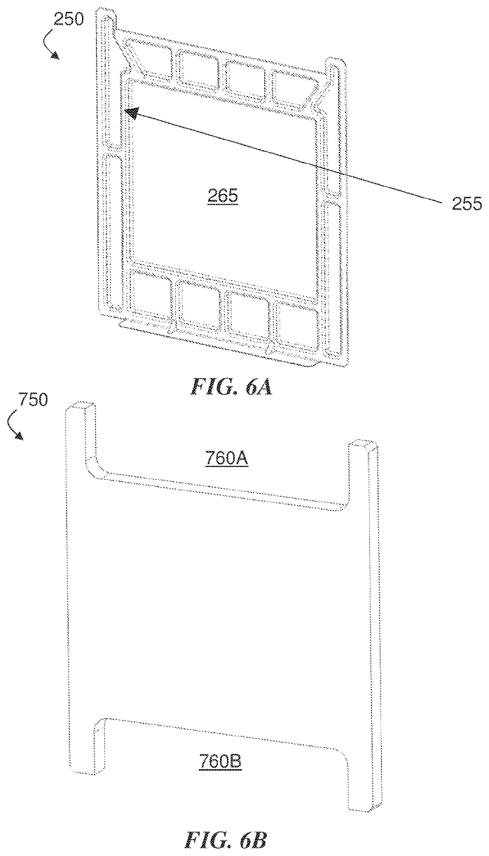

The lateral support component may comprise a main solid body. The main solid body can be in the form of a layer, in some embodiments. A layer is a form factor that has a thickness dimension and two lateral dimensions that are perpendicular to both the thickness dimension and one another, where the lengths of each of the lateral dimensions are at least 3 times the length of the thickness dimension. In some embodiments, the length of the first lateral dimension of the layer is at least 5 times, at least 10 times, at least 25 times, or at least 50 times the length of the thickness dimension of the layer. In some embodiments, the length of the second lateral dimension of the layer is at least 5 times, at least 10 times, at least 25 times, at or at least 50 times the thickness dimension of the layer. In some embodiments, the main solid body may be a fin, a plate, a solid sheet, or a foam sheet, or may comprise any of a variety of other suitable geometries. The main solid body may be relatively planar, but may comprise nonplanarities for any of a variety of purposes, including but not limited to reinforcement of the lateral support component against deformation, and interfacing the lateral support component with the electrochemical cell. In some embodiments, the lateral support component is a unitary object. For example, FIG. 6A presents a perspective schematic diagram of a non-limiting example of a lateral support component 250 that is a unitary object comprising lateral bracing 255 in the form of raised portions of main solid body 265.

In some embodiments, the lateral support component comprises a plurality of mechanically coupled parts. For example, the main solid body of the lateral support component, in some embodiments, may be mechanically coupled with one or more additional solid bodies (e.g., certain examples of lateral bracing, described in more detail below) that interface with the interior boundary of the housing. For example, the lateral support component may comprise a main solid body mechanically coupled to bars located at edges of the lateral support component that interface with the interior boundary of the housing. FIG. 5 is a schematic perspective view illustration showing a non-limiting example of lateral support component 150 which comprises main solid body 165 mechanically coupled to solid bodies 153 and 154 (which have the form of bars located at edges of lateral support component 150, and can serve as lateral bracing, described in more detail elsewhere herein). The lateral support component may further comprise coupling parts such as screws, nails, rivets, adhesive layers, or clamps, that are configured to mechanically couple and maintain the relative positions of independent parts of the lateral support component. Independent parts of the lateral support component may also be connected by any of a variety of other modes of mechanical coupling, such as welding or soldering, which are suitable for the purpose of mechanically coupling parts of the lateral support component. For example, in FIG. 5, lateral support component 150 comprises pop-rivets 175 connecting solid bodies 153 and 154 to main solid body 165. In FIG. 5, main solid body 165 may be thermally conductive, in accordance with some embodiments. The lateral support component may comprise other discrete, mechanically coupled features as well, such as coatings, alignment features (as described below), or sensors, and the disclosure is not so limited.

The lateral support component may be configured to create a cavity within the housing. For example, FIG. 4 presents a non-limiting example of battery 400 comprising housing 402 and lateral support component 350, where lateral support component 350 creates cavity 399 within housing 402. The cavity may reduce the overall weight of the battery, and may create space for battery components, such as electrochemical cell tabs, wires, and/or circuit board components.

Generally, the cavity created by the lateral support component has a lateral area. The “lateral area” of a cavity and of a stack are the areas of those components across a plane that is perpendicular to the direction in which the electrochemical cells are stacked. In some embodiments, the lateral area of the cavity may be at least 1%, at least 5%, at least 10%, at least 20%, at least 30%, (and/or up to 35%, up to 40%, up to 50%, or more) of the lateral area of the stack. Combinations of these ranges (e.g., at least 1% and up to 50%) are also possible. In FIG. 4, for example, cavity 399 has a lateral area that is approximately 20% of the lateral area of the stack enclosed by housing 402.

Lateral support components are generally configured such that they may interface with the interior boundary of the housing. The lateral support component may be configured to transmit force to the housing. Transmission of force from the lateral support component to the housing may prevent an applied anisotropic force from moving the lateral support component, thereby inhibiting lateral motion of the lateral support component, thereby inhibiting lateral motion of electrochemical cells within the stack, and thereby supporting the stack of electrochemical cells against buckling. The lateral support component may be configured to contact the housing, such that it can transmit force to the housing (and, in some cases, while still being permitted to slide along the housing in the direction of the stack). For example, the lateral support component may be configured to be flush with the housing, or may be configured to interface with a track of the housing.

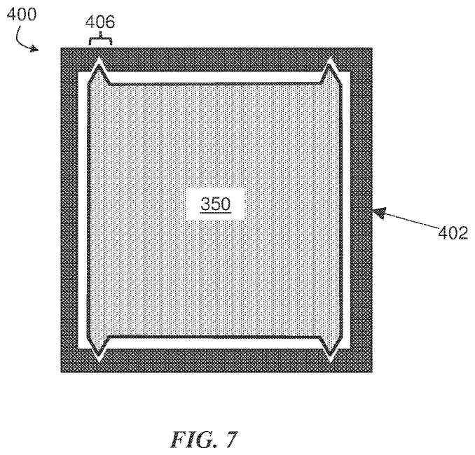

FIG. 7 presents a cross-sectional schematic illustration of non-limiting battery 400 comprising lateral support component 350, which is configured to interface with track 406 of housing 402. The track(s) may have any of a variety of appropriate forms. For example, the track may have the form of a groove configured to receive a protruding portion of the lateral housing component. FIG. 7 shows one such example, where a protrusion of lateral support component 350 is received into a track 406 of housing 402, which has the form of a groove. In some embodiments, the track is a raised portion of the housing, configured to interface with a groove in the lateral support component. Additionally or alternatively, the lateral support component may comprise wheels or ball-bearings that interface with a track of the housing and are configured to allow the lateral support component to roll within the housing.

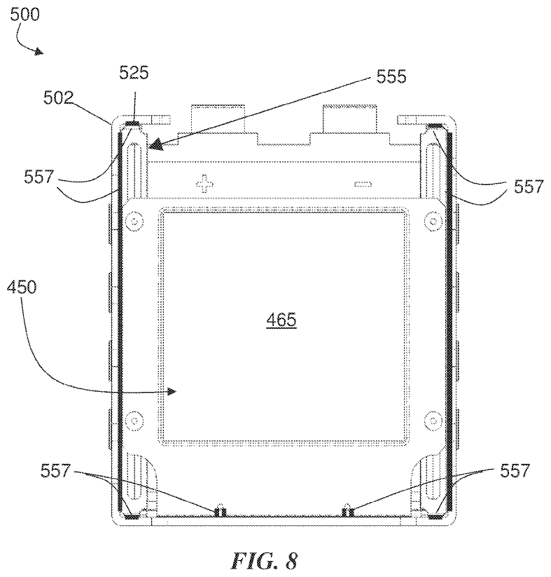

In some embodiments, the lateral support component does not have a mating interface with the housing. For example, in some embodiments, the battery does not comprise a track. FIG. 8 presents a cross-sectional schematic illustration of one such lateral support component, 450, positioned within housing 502 of battery 500. As shown in FIG. 8, lateral support component 450 comprises main solid body 465 as well as additional solid bodies 555 (in the form of bars) that are not configured to interface with a track of housing 502. Rather, additional solid bodies 555 are flush with housing 502.

In some embodiments, a lateral support component comprises a sliding surface configured to slide against a housing of the battery without excessive friction. For example, lateral support component 450 of battery 500 of FIG. 8 comprises sliding surface 525 that is configured to slide against housing 502. The sliding surface may be smooth and/or lubricated to facilitate sliding. In some embodiments, the sliding surface comprises a roller, a ball-bearing, or another rotatable surface that facilitates the sliding.

In some embodiments, multiple portions of a lateral support component are configured to interface with the interior boundary of the housing. In certain cases, interfacing multiple portions of the lateral support component with the interior boundary of the housing may facilitate easier axial motion of the lateral support component, greater inhibition of lateral motion of the lateral support component, and/or improved resistance to deformation. Referring again to FIG. 8, for example, portions 557 of lateral support component 450 (indicated by bold lines) are all configured to interface with the interior boundary of the housing. In some embodiments, the lateral support component comprises greater than or equal to 1, 2, 3, 4, 5, 10, 15, or more portions configured to interface with the interior boundary of the housing, and the disclosure is not so limited.

In the context of the present disclosure, it has been recognized that bending of lateral support components (e.g., in a direction substantially parallel to the direction in which the cells are stacked) under an applied anisotropic load could contribute to buckling of the stack. The problem of bending can be exacerbated in batteries or stacks of electrochemical cells with high aspect ratios, because bending of individual battery components may cumulatively contribute to overall buckling and/or misalignment of the stack.

In some embodiments, the lateral support component comprises lateral bracing. The lateral bracing is generally configured to inhibit (e.g., prohibit) bending of the lateral support component (e.g., in a direction substantially parallel to the direction in which the cells are stacked).

The lateral bracing may inhibit bending of the lateral support component by providing a relatively thick cross-section relative to other portions of the lateral support component, and/or having a higher elastic modulus relative to other portions of the lateral support component. Without wishing to be bound by any particular theory, the relatively thicker cross-section and/or the relatively higher elastic modulus of the lateral bracing may furnish it with greater resistance to bending in response to applied lateral force. Thus, the lateral bracing may be configured to increase the lateral support component's overall resistance to bending in response to lateral forces acting on the lateral support component. In some embodiments, lateral bracing may advantageously increase the ability of a lateral support component to resist bending without excessive increase in weight or thickness (e.g., by reinforcing the lateral support component without using excess material).

Accordingly, in some embodiments, the lateral bracing of the lateral support component has a thickness that is greater than the thickness of the main solid body of the lateral support component. For example, in some embodiments, the main solid body of the lateral support component can comprise a layer having a thickness, and the lateral support component can comprise a dimension parallel to the thickness dimension of the main solid body of the lateral support component that is at least 2 times (or at least 2.5 times, at least 3 times, at least 4 times, or at least 5 times, and/or up to 10 times, up to 20 times, or more) greater than the thickness of the main solid body of the lateral support component. As one example, in FIG. 5, lateral bracing 155 (which is in the form of a bar) has a thickness 160 that is about 3 times greater than the thickness of main solid body 165.

In some embodiments, the lateral bracing of the lateral support component has an elastic modulus that is greater than the elastic modulus of the main solid body of the lateral support component. For example, in some embodiments, the elastic modulus of the lateral bracing is at least 1.5, at least 2, at least 2.5, at least 5, at least 10, at least 20 (and/or, up to 100, up to 1,000, or more) times the elastic modulus of the main solid body of the lateral support component.

In some embodiments, the lateral bracing is an integral part of a unitary lateral support component (e.g., the bracing may be a ridge, a crimp, a fold, a roll, or a raised portion of the lateral support component). For example, in FIG. 6A, lateral support component 250 comprises lateral bracing 255 in the form of raised portions extending across main solid body 265 and circumscribing the lateral support component. The raised portions of the lateral bracing also produce a non-planarity in lateral support component 250 that is adjacent to main solid body 265 and configured to couple with an electrochemical cell, as discussed in greater detail above.

The present disclosure is not limited to the use of lateral bracing that is integral with the main solid body, and in some embodiments, the lateral bracing may include one or more solid bodies that are separate from the main solid body of the lateral support component. The solid bodies of the lateral bracing can, in some embodiments, be mechanically coupled to a main solid body of the lateral support component. For example, the lateral bracing may comprise one or more bars of the lateral support component. A “bar” is a form factor having a length and two dimensions that are perpendicular to each other and to the length, where the two dimensions are each less than or equal to 0.5 times the length dimension. In some embodiments, the two dimensions of the bar that are perpendicular to each other and to the length are less than or equal to 0.4, less than or equal to 0.3, less than or equal to 0.2, less than or equal to 0.1, or less than or equal to 0.05 times the length dimension. A bar's orientation (e.g., its condition as substantially parallel or substantially perpendicular to another bar) is defined in terms of its length direction.

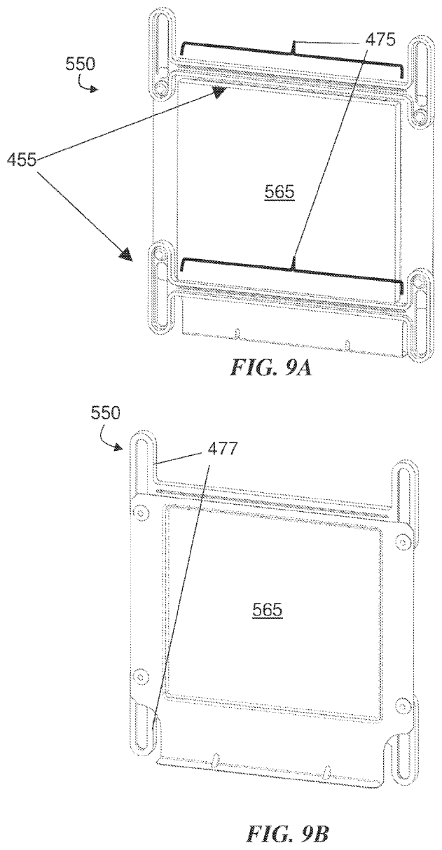

In some embodiments, the bars of the lateral bracing are located at opposing edges of the lateral support component. The bars may be substantially parallel to one another. FIG. 5 provides an example, where lateral bracing 155 comprises bars 153 and 154, which are substantially parallel and are located at opposing edges of lateral support component 150. FIGS. 9A-9B present another example, providing schematic, perspective illustrations of a non-limiting lateral support component 550 that includes main solid body 565 and solid bodies 455 in the form of bars that comprise lengths 475. In FIGS. 9A-9B, bars 455 would be considered to be substantially parallel because lengths 475 of the bars are substantially parallel.

In some embodiments, the lateral bracing comprises a length of greater than or equal to 50%, greater than or equal to 60%, greater than or equal to 70%, greater than or equal to 80%, greater than or equal to 90%, greater than or equal to 95%, or more (e.g., up to 100%, up to 110%, up to 120%, or more) of a length of a dimension of the lateral support component that is substantially parallel to the length of the bar.

In some embodiments, the bar comprises an elongated region. The elongated region may be capped by regions substantially perpendicular to the main elongated region to form a “T” shape or an “I” shape. For example, in FIGS. 9A-9B, the bars comprise elongated region 475 of lateral support component 550, which are capped by regions 477 (and regions 477 are substantially perpendicular to elongated region 475). In some embodiments, the substantially perpendicular regions are configured to create a cavity in the housing, as discussed above.

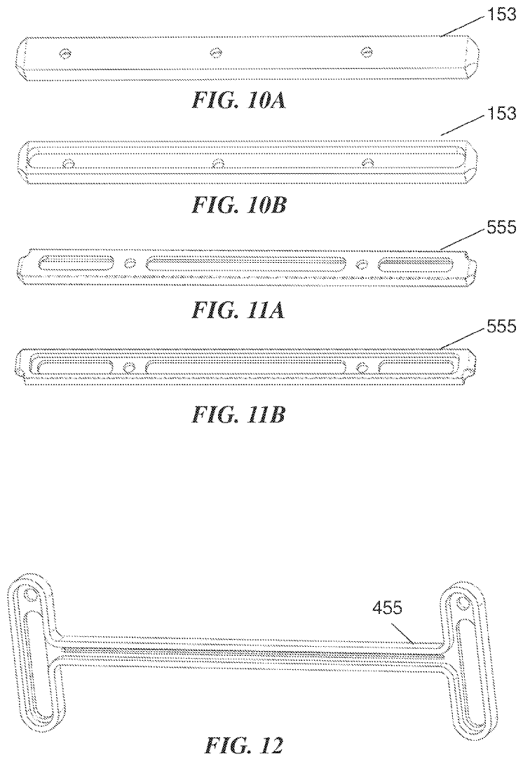

Lateral bracing (e.g., a bar) may have uniform thickness, or may comprise recesses, holes, or other features that contribute to a non-uniform thickness of the lateral bracing. FIGS. 10A-10B present schematic illustrations of various perspectives of lateral bracing 153, in the form of a bar configured to be mechanically coupled to a main solid body of a lateral support component. For example, the lateral bracing of FIGS. 10A-10B is illustrated in FIG. 5, where lateral bracing 153 is coupled to main solid body 165 of lateral support component 150 by rivets 175. Similarly, FIGS. 11A-11B present schematic illustrations of various perspectives of non-limiting solid bracing 555, in the form of a different bar, configured to be mechanically coupled to a main solid body of a lateral support component. For example, FIG. 8 presents non-limiting lateral support component 450 comprising lateral bracing 555 mechanically coupled to main solid body 465. FIG. 12 presents a schematic, perspective illustration of lateral bracing 455, as shown in FIGS. 9A-9B.

In some embodiments, lateral support components do not require lateral bracing. For instance, a lateral support component may be a main solid body of a material with sufficient thickness to prevent deformation. However, in the context of the present disclosure, it has been recognized that reducing a weight and/or thickness of the lateral support component may be advantageous for applications where excessive weight and/or battery size is undesirable. Thus, in some embodiments, batteries as described herein comprise lateral bracing as a mechanism for improving mechanical reinforcement while limiting excessive use of material.

In some embodiments, the stack of electrochemical cells can include an endplate at one or both ends of the stack. The endplate can, in some embodiments, be configured such that it interfaces with the housing such that is lateral movement is restricted or prevented during application of the anisotropic force to the stack. One example of an endplate is shown in FIG. 6B, which is a perspective view schematic diagram of endplate 750. The edges of endplate 750 can interface with the interior of the housing such that the lateral movement of the endplate is restricted while an anisotropic force is applied to the cell stack. In some embodiments, the endplate forms one or more cavities with respect to the battery housing when positioned within the stack. As shown in FIG. 6B, for example, when endplate 750 is positioned within the stack, cavities between the end plate and the housing are formed at locations 760A and 760B.

In some embodiments, the lateral support component may be configured such that the housing permits motion of the lateral support component in a direction substantially perpendicular to the electrode surface (e.g., a direction that would be substantially parallel to a component of anisotropic force perpendicular to an electrode surface, according to some embodiments). Referring again to FIG. 1A, for example, housing 102 permits motion of lateral support component 150 within the housing, in a direction substantially parallel to anisotropic force component 182. For example, in some embodiments, the lateral support component is configured such that the housing would, in the absence of the electrochemical cells, permit motion of the lateral support component in a direction substantially parallel to the component of the anisotropic force perpendicular to an electrode surface of the electrochemical cell. For example, in FIG. 1A, in the absence of electrochemical cell 110, lateral support component 150 could move freely in the direction of anisotropic force component 182. Thus, in some embodiments, the lateral support component may be configured to slide, roll, or move via any of a variety of other modalities in the direction substantially perpendicular to the electrode surface. In some embodiments, the lateral support component is configured to permit motion of the electrochemical cell(s) of the battery in a direction substantially perpendicular to the electrode surface while inhibiting (e.g., preventing) motion of the electrochemical cell(s) in a direction substantially parallel to the electrode surface. For example, the lateral support component may inhibit motion of the electrochemical cell(s) via friction. Advantageously, the configurations of lateral support components that permit motion of the electrochemical cell in a direction substantially perpendicular to the electrode surface but restrict motion of the electrochemical cell in direction substantially parallel to the electrode surface may permit transmission of the anisotropic force through the stack of electrochemical cells while limiting lateral displacement of the electrochemical cells. For example, referring again to FIG. 1A, lateral support component 150 permits transmission of anisotropic force component 182 but restricts lateral motion of electrochemical cells 110 and 120. Such configurations may permit the battery to benefit from the application of anisotropic force while limiting risk of detrimental bending, distortion, or misalignment of battery components (e.g., electrochemical cells, thermally conductive solid article portions, thermally insulating solid article portions, etc.).

In some embodiments, the coefficient of static friction between one or more (or all) cells of the battery and an adjacent lateral support component is relatively high. For example, in some embodiments, the coefficient of static friction between one or more (or all) cells of the battery and an adjacent lateral support component is at least 0.4, at least 0.5, at least 0.6, at least 0.7, at least 0.8, at least 0.9, at least 0.95, at least 0.97, at least 0.99, or higher.

In some embodiments, a method of assembling a battery comprises applying an anisotropic force to a stack of electrochemical cells, such that a lateral support component within the battery or stack of electrochemical cells moves in a direction substantially parallel to a component of the anisotropic force to reach an equilibrium position. For example, the lateral support component may slide within the housing, in some embodiments. In some embodiments, the lateral support component may roll within the housing (e.g., via wheels or ball bearings fixed to the lateral support component and configured to roll within the housing).

As discussed above, in some embodiments, the lateral support component inhibits motion of the electrochemical cell (e.g., the first electrochemical cell, the second electrochemical cell) in at least one direction that is not substantially parallel to the component of anisotropic force that is perpendicular to the electrode surface. However, the lateral support component may be more restrictive still. The lateral support component may be configured to inhibit motion of the electrochemical cell in any direction that is not substantially parallel to the component of the anisotropic force perpendicular to the electrode surface. For example, the lateral support component may be configured to prevent motion of the electrochemical cell in any direction that is not substantially parallel to the component of anisotropic force perpendicular to the electrode surface.

In some embodiments, the battery comprises a stack comprising electrochemical cells (e.g., the first electrochemical cell, the second electrochemical cell). It should be understood that the stack may be a multicomponent stack comprising non-cell components such as thermally insulating compressible solid article portions, thermally conductive solid article portions, lateral support components, and/or sensors. In some embodiments, the stack includes a solid plate. In some embodiments, the stack is at least partially enclosed by a housing comprising a solid plate.

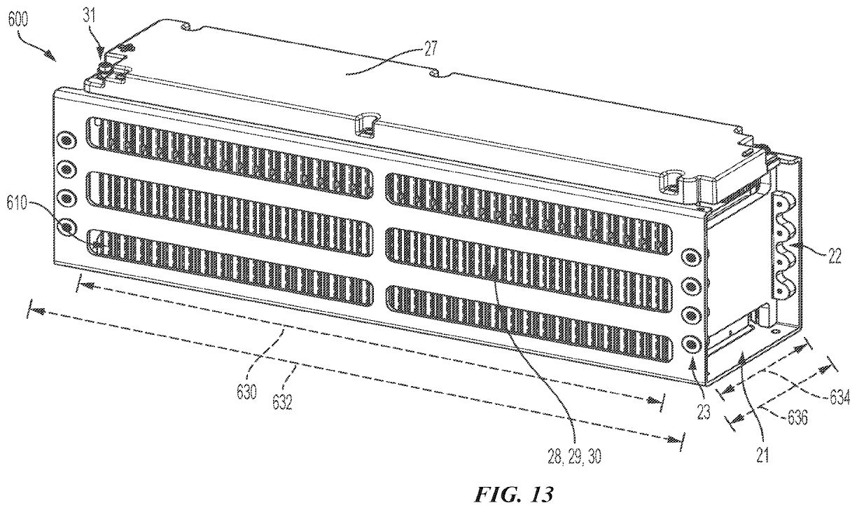

The stack of electrochemical cells may have an aspect ratio defined by a ratio between a length of a smallest lateral dimension of the stack of electrochemical cells and a length of the stack of electrochemical cells. FIG. 13 presents a perspective view schematic illustration of a non-limiting example of a battery 600 comprising stack of electrochemical cells 610 having length 630 and smallest lateral dimension 634. In some embodiments, the stack of electrochemical cells has an aspect ratio of greater than or equal to 1, greater than or equal to 1.5, greater than or equal to 2, greater than or equal to 3, greater than or equal to 5, or greater. In some embodiments, the stack of electrochemical cells has an aspect ratio of less than or equal to 20, less than or equal to 10, less than or equal to 8, or less than or equal to 6. Combinations of these ranges are possible. For example, in some embodiments, stack of electrochemical cells has an aspect ratio of greater than or equal to 1 and less than or equal to 20.

The battery may have an aspect ratio defined by a ratio between a length of a smallest lateral dimension of the battery and a length of the battery. Referring again to FIG. 13, battery 600 has length 632 and smallest lateral dimension 636. In some embodiments, the battery has an aspect ratio of greater than or equal to 1, greater than or equal to 1.5, greater than or equal to 2, or greater. In some embodiments, the battery has an aspect ratio of less than or equal to 20, less than or equal to 10, less than or equal to 5, less than or equal to 3, less than or equal to 2, or less. Combinations of these ranges are possible. For example, in some embodiments, battery has an aspect ratio of greater than or equal to 1 and less than or equal to 20. In some embodiments, the aspect ratio of the stack of electrochemical cells is relatively close to the aspect ratio of the battery; however, these aspect ratios may also be different, and the disclosure is not so limited.

As mentioned above, in some embodiments, the battery comprises a housing. The housing may at least partially enclose the electrochemical cells of the stack. In some embodiments, the battery comprises one or more solid plates that are part of the housing. In some such cases, the housing is configured to apply the anisotropic force via a solid plate. The solid plates may be, for example, endplates configured to apply an anisotropic force to the electrochemical cells of the stack. For example, in FIG. 3A, first solid plate 310 and second solid plate 312 are endplates. It should be understood that the surfaces of a solid plate do not necessarily need to be flat. For example, one of the sides of the solid plate may comprise a surface that is curved (e.g., contoured, convex) in the absence of an applied force. In some embodiments, the solid plate (e.g., a carbon fiber plate or an aluminum solid plate) is convex with respect to the electrochemical cells in the absence of an applied force, and under at least one magnitude of applied force the endplate may become less convex (e.g., become flat).

The housing may comprise any suitable solid material. In some embodiments, a solid plate of the housing and/or stack is or comprises a metal, metal alloy, composite material, or a combination thereof. In some cases, the metal that the solid plate is or comprises is a transition metal. For example, in some embodiments, the solid article is or comprises Ti, Cr, Mn, Fe, Co, Ni, Cu, or a combination thereof. In some embodiments, the solid plate is or comprises a non-transition metal. For example, in some embodiments, the solid article is or comprises Al, Zn, or combinations thereof. Metal alloys that the solid plate can be or comprise include alloys of aluminum, alloys of iron (e.g., stainless steel), or combinations thereof, in some embodiments. Composite materials that the solid plate can be or comprise include, but are not limited to, reinforced polymeric, metallic, or ceramic materials (e.g., fiber-reinforced composite materials), carbon-containing composites, or combinations thereof, according to some embodiments.

In some embodiments, a solid plate (e.g., solid plate 201) of the housing and/or stack comprises carbon fiber. Carbon fiber may be present in the solid plate in a relatively high amount (e.g., greater than or equal to 50 wt %, greater than or equal to 75 wt %, greater than or equal to 90 wt %, greater than or equal to 95 wt %, greater than or equal to 99 wt %, 100 wt %). In some embodiments, the solid plate comprises multiple layers of carbon fiber (e.g., unidirectional carbon fiber). Further details of potentially suitable carbon fiber plates are described, for example, in U.S. Patent Publication No. 2021/0151839 A1, published on May 20, 2021, and entitled, “BATTERIES, AND ASSOCIATED SYSTEMS AND METHODS,” which is incorporated herein by reference in its entirety for all purposes.

In some embodiments, the battery has a relatively small volume. In some embodiments, the battery has a volume of less than or equal to 15000 cm³, less than or equal to 13500 cm³, less than or equal to 12000 cm³, less than or equal to 10000 cm³, less than or equal to 8000 cm³, less than or equal to 6750 cm³, less than or equal to 6000 cm³, less than or equal to 5000 cm³, and/or as low as 4000 cm³, or lower. As described in more detail below, certain configurations of the housing may provide for an ability to enclose a relatively large amount of electrochemical cell volume and/or apply relatively high force while having a relatively small housing volume.

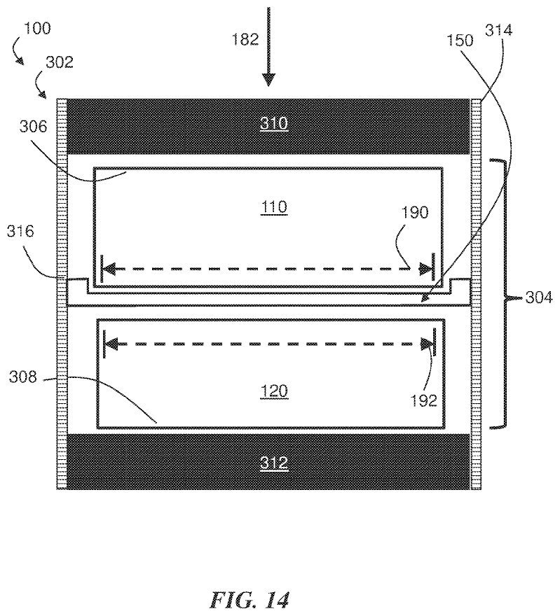

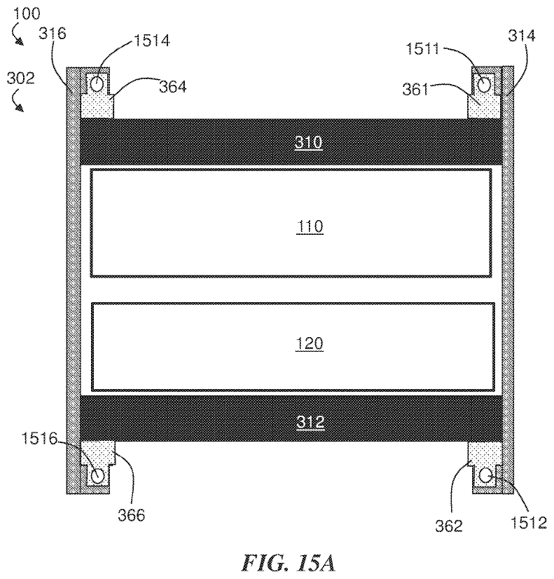

In some embodiments, the housing of the battery further comprises a solid housing component coupled to a solid plate. In some embodiments, the solid housing component is a discrete object separate from the solid plate rather than part of a unitary object with the solid plate (though in some embodiments the solid housing component and the solid plate are part of a unitary solid object). The solid housing component (e.g., discrete solid housing component) may contribute, at least in part, to application of anisotropic force by the housing (e.g., to an electrochemical cell in the stack). For example, in some embodiments, the housing is configured to apply, via the solid plate and tension in the solid housing component coupled to the solid plate, during at least one period of time during charge and/or discharge of the first electrochemical cell and/or the second electrochemical cell, an anisotropic force with a component perpendicular to a first electrode surface of the first electrochemical cell and/or a second electrode surface of the second electrochemical cell. As noted above, the anisotropic force may define a pressure of at least 3 kg_{f}/cm², at least 5 kg_{f}/cm², at least 10 kg_{f}/cm², at least 12 kg_{f}/cm², at least 20 kg_{f}/cm², and/or up to 25 kg_{f}/cm², up to 30 kg_{f}/cm², up to 35 kg_{f}/cm², up to 40 kg_{f}/cm², or more. The solid housing component (e.g., discrete solid housing component) may contribute to force application by being coupled to a first solid plate (e.g., covering at least a portion of a first end of the stack, or a solid plate between the solid housing component and the first electrochemical cell) and a second component of the housing covering at least a portion of a second end of the stack (e.g., a second solid plate or a part of a frame). For example, FIG. 14 presents a cross-sectional, schematic illustration of a non-limiting example of battery 100, which comprises housing 302 that comprises solid housing component 314 coupled to first solid plate 310 (which covers first end 306 of stack 304) and second solid plate 312 (which covers second end 308 of stack 304). Tension in solid housing component 314 may contribute force causing first solid plate and/or second solid plate 312 to compress stack 304, thereby applying an anisotropic force in direction of arrow 182 having component 182 perpendicular to a first electrode surface of first electrochemical cell 110 and/or a second electrode surface of second electrochemical cell 120. In FIG. 14, battery 100 further comprises lateral support component 150, which may help prevent lateral motion of the electrochemical cells and/or may resist bending under the application of anisotropic force.

The solid housing component may couple (or contribute to coupling of) the solid plate covering at least a portion of a first end of the stack to a component of the housing covering at least a portion of second end of the stack. Such a coupling via the solid housing component (e.g., solid housing component 314) may contribute to the anisotropic force applied by the housing. In some embodiments, the solid housing component spans from the solid plate to the second end of the stack. For example, in FIG. 14, solid housing component 314 spans from first solid plate to second end 308 of stack 304. It should be understood that an object spanning from a first element to a second element may extend past some or all of either the first element of the second element, provided that it reaches at least a portion of each the two elements in the direction of the spanning. For example, in FIG. 14, solid housing component 314, which reaches all of but does not extend past solid plate 310 and extends past second end 308, is considered to span from solid plate 310 to second end 308. In some embodiments in which the housing comprises a first solid plate covering at least a portion of the first end of the stack and a second solid plate covering at least a portion of the second end of the stack (e.g., as shown in FIG. 14), the solid housing component spans from the first solid plate to the second solid plate.

Solid housing components may join two or more parts of the housing via any of a variety of coupling techniques. The solid housing components may be part of the underlying structure of the housing. For example, in some embodiments, the housing comprises a frame at least partially enclosing the stack, and a solid housing component is a part of the frame (e.g., a side of the frame joining two ends of the frame). For example, battery 600 of FIG. 13 comprises non-limiting frame 21, as is described in greater detail below. The housing may have a single solid housing component, or the housing may comprise multiple solid housing components. In some embodiments, the housing comprises a first solid housing component along a first side of the stack and a second solid housing component on along a second (e.g., opposite) side of the stack. Housing 302 in FIG. 14 shows one such embodiment, where first solid housing component 314 and second solid housing component 316 are along opposite sides of stack 304.

The solid housing component may be made of any of a variety of materials, depending on desired properties of the solid housing component and/or the overall battery. The solid housing component may be made of any of the materials described above for the solid plate. In some embodiments, the solid housing component comprises a metal (e.g., aluminum, titanium, etc.), metal alloy (e.g., stainless steel), composite, polymeric material (e.g., a rigid plastic), or combination thereof. In some embodiments, the solid housing component comprises a composite material. Examples of composite materials that the solid housing component can be or comprise include, but are not limited to, reinforced polymeric, metallic, or ceramic materials (e.g., fiber-reinforced composite materials), carbon-containing composites, or combinations thereof. For example, in some embodiments, the solid housing component comprises carbon fiber. As described above in the context of the solid plate, the solid housing component may comprise multiple layers of carbon fiber (e.g., unidirectional carbon fiber weaves, optionally with binder). Further details of potentially suitable carbon fiber housing components are described, for example, in U.S. Patent Publication No. 2021/0151839 A1, published on May 20, 2021, and entitled, “BATTERIES, AND ASSOCIATED SYSTEMS AND METHODS,” which is incorporated herein by reference in its entirety for all purposes.

The solid housing component may have any of a variety of lengths while maintaining rigidity. In some embodiments, such a rigidity even at relatively long lengths affords an ability for the ratio of the distance between a solid plate and the second end of the stack to the largest lateral dimension of the housing to be relatively large if desired. In turn, such a large ratio may allow for a relatively large number (e.g., at least 6, at least 12, or more) of electrochemical cells to be included in the stack of the battery. In some embodiments, the ratio of the distance between a solid plate and the second end of the stack to the largest lateral dimension of the battery is less than or equal to 20, less than or equal to 10, less than or equal to 5, less than or equal to 2, less than or equal to 1.5, less than or equal to 1, less than or equal to 0.5, less than or equal to 0.2, less than or equal to 0.1, or less. In some embodiments, the ratio of the distance between a solid plate and the second end of the stack to the largest lateral dimension of the battery is greater than or equal to 0.01, greater than or equal to 0.1, greater than or equal to 0.5, greater than or equal 1, greater than or equal to 2, greater than or equal to 5, or greater. Combinations of the above ranges are also possible.

In some embodiments, the solid housing component is coupled to the solid plate via coupling to a housing stop portion adjacent to an exterior surface of the solid plate. The housing stop portion may be directly adjacent to the exterior surface of the solid plate (a surface of the plate facing away from the stack). However, in some embodiments, the housing stop portion is indirectly adjacent to the exterior surface of the solid plate such that one or more intervening components (e.g., washers, layers of material, etc.) is between the housing stop portion and the exterior surface of the solid plate. The housing stop portion may be discrete from the solid housing component and/or the solid plate. The housing stop portion may be made of any of a variety of materials, such as a metal (e.g., aluminum or titanium), a metal alloy (e.g., stainless steel), a composite (e.g., carbon fiber), a polymeric material (e.g., a rigid plastic), or a combination thereof. The housing stop portion may have any of a variety of shapes depending on, for example, a desired deflection of the solid plate and/or pressure distribution within the battery. It has been realized that some shapes of housing stop portions (e.g., elongated bars, or rings (e.g., rectangular or non-rectangular rings) conforming to a perimeter of the solid plate) can distribute force (e.g., from tension in the solid housing component) across the face of the solid plate more uniformly than, for example, solid plates coupled via discrete auxiliary fasteners (e.g., bolts with nuts) in contact with relatively small areas of the solid plate. In some embodiments, a housing stop portion has spaces, which may allow for the stop portion to have a relatively low mass for its overall geometric dimensions, which may be useful in some instances where relatively high specific energy density of the battery is desired. Further description of housing stop portions comprising spaces is provided in U.S. Publication No. US-2022-0311081-A1, published on Sep. 29, 2022, filed as U.S. application Ser. No. 17/702,971 on Mar. 24, 2022, and entitled “BATTERY PACK AND RELATED COMPONENTS AND METHODS.” incorporated by reference herein in its entirety. Referring to FIGS. 3A-3C, battery 100 may be configured such that first solid housing component 314 is coupled to first solid plate 310 via coupling of the first solid housing component 314 to first housing stop portion 361 adjacent to exterior surface 335 of first solid plate 310. In some embodiments first solid housing component 314 is coupled to second solid plate 312 via coupling of first solid housing component 314 to second housing stop portion 362 adjacent to exterior surface 337 of second solid plate 312. Non-limiting battery 100 may further be configured as illustrated in FIGS. 3A-3C, such that second solid housing component 316 is coupled to first solid plate 310 via coupling of second solid housing component 316 to third housing stop portion 364 adjacent to exterior surface 335 of first solid plate 310, as well as to second solid plate 312 via coupling of first solid housing component 314 to fourth housing stop portion 366 adjacent to exterior surface 337 of second plate 312. The couplings between housing stop portions and solid housing components may comprise, for example, welds, fasteners, adhesives, or combinations thereof. A housing of this type may, in some embodiments, decrease a largest lateral pressure-applying dimension of the housing relative to a housing comprising, for example, fasteners coupling solid plates.

FIG. 3A shows a front view schematic illustration of a non-limiting example of battery 100 comprising first electrochemical cell 110, lateral support component 150, and second electrochemical cell 120 according to some embodiments, where all housing stop portions are identical. FIG. 3B shows an exploded perspective of the same battery 100, and FIG. 3C shows a perspective illustration of the same battery 100. It should be understood that other embodiments, where housing stop portions have different geometries from each other, are possible, as are embodiments with more or fewer solid housing components and/or housing stop portions. In some embodiments, stop portions are discrete, as illustrated by FIGS. 3A-3C. However, in some embodiments, stop portions are portions of a single unitary object connected to multiple solid housing components (e.g., a first solid housing component and a second solid housing component). For example, FIG. 3D illustrates an embodiment where stop portion 361 and stop portion 364 are portions of single unitary object 321. The geometry of the stop portion may be configured to apply force to and/or support a relatively large area of the solid plate, in contrast to auxiliary fasteners (e.g., a bolt and nut), which may apply pressure in a fairly localized region. In some embodiments, at least 50%, at least 60%, at least 75%, at least 90%, at least 95%, at least 99%, or 100% of a perimeter of an exterior surface of a solid plate is covered by (e.g., adjacent to) one or more housing stop portions.

The solid housing component may be coupled to the housing stop portion via any of a variety of suitable techniques. For example, the solid housing component may be coupled to the housing stop portion via a weld, a fastener, an adhesive, or a combination thereof.

In some embodiments (e.g., in which the battery is part of a vehicle), it is advantageous to couple a battery to a body external to the battery. For example, the battery may be mechanically coupled to the body external to the battery (e.g., by anchoring the battery to the body). Anchoring a housing stop portion of the battery to an external body can provide a number of performance advantages. In some embodiments, for example, anchoring the housing stop portion to an external body provides strong mechanical support to a stack of electrochemical cells. Anchoring the housing stop portion to the external body can also improve the performance of other housing components, such as solid housing components. For example, in some embodiments, housing stop portions anchored to external bodies can transmit force from the stack of electrochemical cells directly to the external body, bypassing other housing components such as solid housing components, and reducing housing stress.

In some embodiments, housing stop portions are more resistant to deformation than other housing components. For example, housing stop portions may be thicker and/or may be made of stronger materials than other housing components. The use of the housing stop portions for direct transmission of force to the external body may thus have benefits for the construction of relatively lightweight batteries by reducing the load on other housing components (e.g., solid housing components), which may allow the other housing components to be made thinner and/or more lightweight.

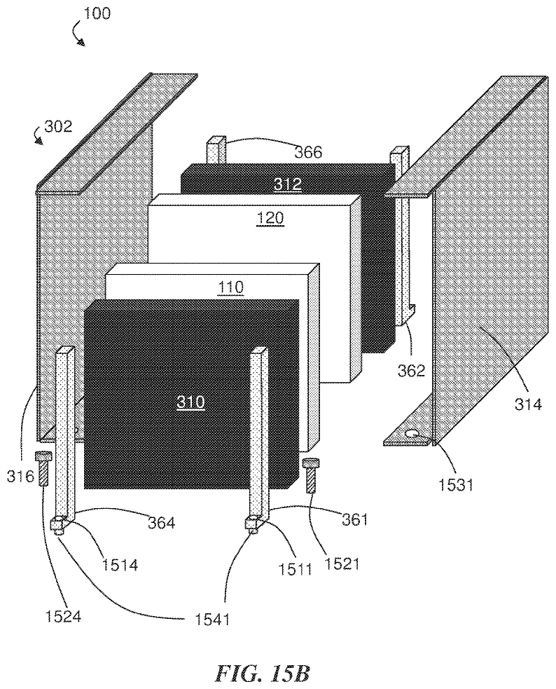

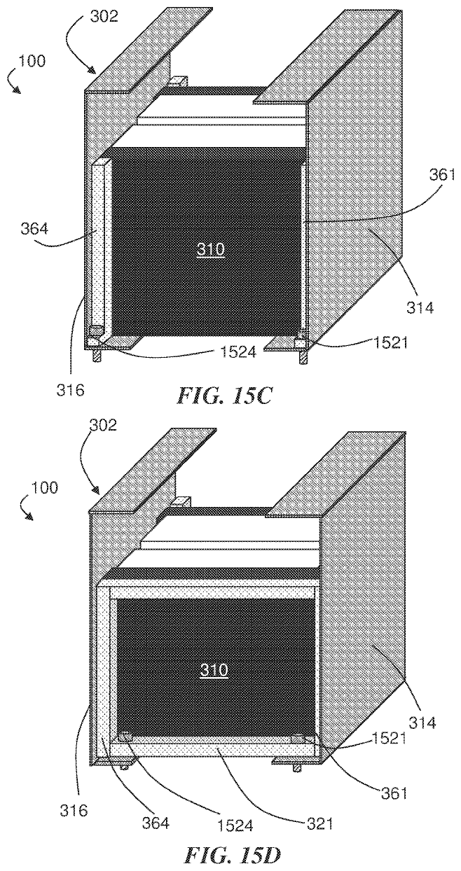

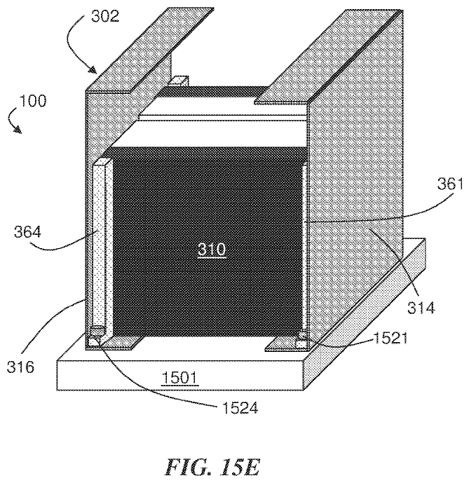

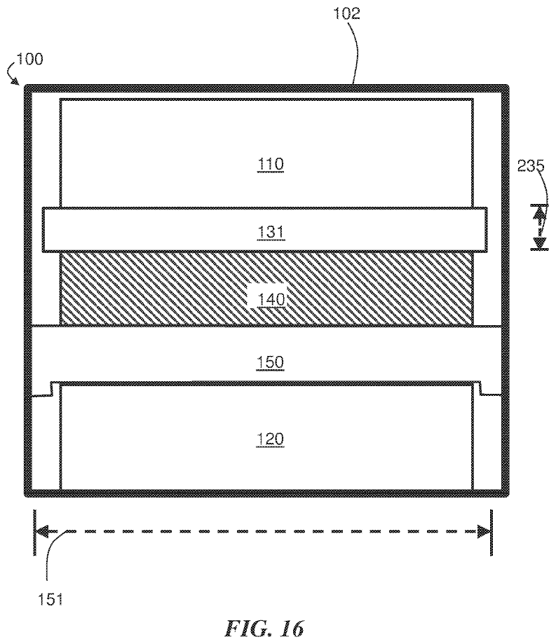

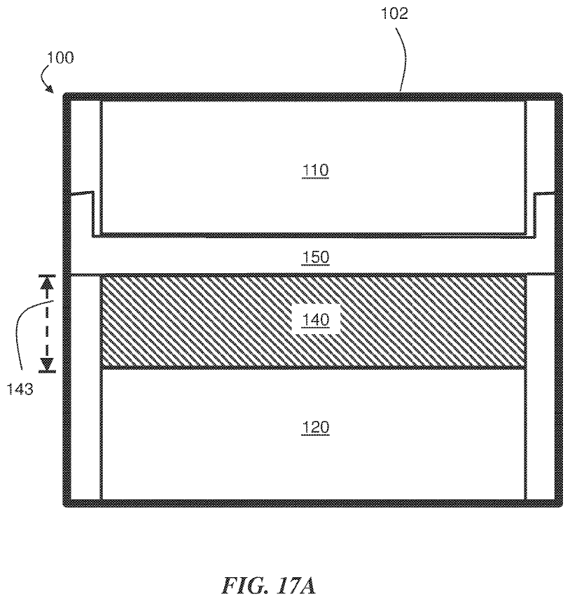

FIGS. 15A-15E show schematic diagrams of a non-limiting example of battery 100 comprising electrochemical cells 110 and 120, and housing 302 comprising solid plates 310 and 312, solid housing components 314 and 316, and housing stop portions 361, 362, 364, and 366. As shown in FIG. 15E, housing stop portions 361, 362, 364, and 366 may be configured to be anchored to external body 1501.

FIG. 15A shows a cross-sectional schematic diagram of battery 100, showing that housing stop portions 361, 362, 364, and 366 may each be configured to be anchored by passing at least portions of fasteners (shown in FIGS. 15B-15D) through holes 1511, 1512, 1514, and 1516, respectively. Generally, any or all housing stop portions of the battery may be configured to be anchored. For example, in FIG. 15A, all four housing stop portions 361, 362, 364, and 366 are configured to be bolted to an external body. However, it is not necessary for every housing stop portion to be anchorable to an external body. For simplicity, other battery components discussed herein (e.g., lateral support components) are not included in the batteries of FIGS. 15A-15E, but it should of course be understood that use of anchored housing stop portions is not limited to the specific batteries shown in FIGS. 15A and 15B, and that in general anchoring of housing stop portions may be used in batteries comprising any of a variety of combinations of battery components discussed herein (e.g., lateral support components).

FIG. 15B shows an exploded perspective view schematic diagram of battery 100, along with fasteners 1521 and 1524, configured such that at least a portion of fasteners 1521 and 1524 pass through holes 1511 and 1514, respectively, to anchor housing stop portions 361 and 364 to an external body (e.g., external body 1501 shown in FIG. 15E). Although fasteners 1521 and 1524 are presented as bolts, the housing stop portion may be anchored to an external body via any of a variety of suitable fasteners. For example, fasteners that may be used include, but are not limited to: a bolt, a nail, a pin, a screw, a nut, a peg, a rod (e.g., a threaded rod, a rod with interlocking features), a rivet, a tie, a clip (e.g., a side clip, a circlip), or a cam-fastener. An appropriate fastener may be chosen based on compatibility of the fastener with the battery and with the external body. For example, a fastener may be chosen such that at least a portion of the fastener can pass through the solid housing component and/or to pin at least some of the solid housing component between the housing stop portion and the external body. For example, in FIG. 15B, fasteners 1521 and 1524 are configured to pass through holes 1531 in solid housing components 314 and 316

In some embodiments, a fastener interlocks with a portion of the housing stop portion and/or with a portion of the solid housing component. For example, referring again to FIG. 15B, fasteners 1521 and 1524 may be configured to interlock with holes 1511 and 1514 because fasteners 1521 and 1524 may be threaded bolts and holes 1511 and 1514 may be threaded holes with threading complementary to threaded bolts 1521 and 1524. FIG. 15C shows a perspective view schematic diagram of assembled battery 100, wherein fasteners 1521 and 1524 are interlocked with the housing stop portions. Similarly, the fastener may interlock with a portion of the external body (e.g., by interlocking with a threaded bore of the external body).

A housing stop portion may be configured to be anchored to the external body via more than one fastener. For example, FIG. 15D shows a perspective view schematic diagram of battery 100 where housing stop portion 361 and housing stop portion 364 are portions of single unitary object 321 (a similar embodiment is discussed above with reference to FIG. 3D). In some instances where housing stop portions 361 and 364 are part of unitary object 321, they are able to distribute force to both fasteners 1521 and 1524 and are therefore each anchorable by both fasteners.

The housing stop portion of a battery may be configured to be anchored to any of a variety of external bodies, and is not limited to use with any particular external body. In some embodiments, an external body is configured to mechanically couple with a fastener. For example, the external body may comprise a hole, a threaded bore, an inset, or any of a variety of other features configured to interlock with the fastener. The external body may be a rigid body. The external body may be a portion of a battery holder (e.g., of a vehicle or a battery bank). FIG. 15E shows a perspective view schematic diagram of assembled battery 100 (identical to battery 100 of FIG. 15C), where fasteners 1521 and 1524 anchor housing stop portions 361 and 364 to external body 1501. As shown in FIG. 15E, external body 1501 is configured to mechanically couple with fasteners 1521 and 1524 (represented as bolts) because external body 1501 includes threaded bores (beneath the fasteners but not visible) configured to interlock with the fasteners.

It may be advantageous for the housing stop portion to be anchored such that it is adjacent to the external body. Adjacency between the housing stop portion and the external body can reduce the load on other housing components by transmitting force more directly to the external body directly. The housing stop portion could be directly adjacent to the external body, which may be advantageous because it provides the most direct force transmission from the housing stop component to the external body. However, in some embodiments the housing stop portion may be separated from the external body by one or more intervening components (e.g., shock absorbers, sensors, or stabilization features of the battery) which may provide alternative performance advantages.

A battery may be configured such that when a housing stop portion of the battery is anchored to an external body, the housing stop portion is adjacent to the external body such that a minimum distance between the housing stop portion and the external body is less than or equal to 10 cm, less than or equal to 5 cm, less than or equal to 2 cm, less than or equal to 1 cm, less than or equal to 0.5 cm, less than or equal to 0.25 cm, less than or equal to 0.1 cm, less than or equal to 0.05 cm, or less. In some embodiments, the housing stop portion is adjacent to the external body such that a minimum distance between the housing stop portion and the external body is greater than or equal to 0 cm, greater than or equal to 0.05 cm, greater than or equal to 0.1 cm, greater than or equal to 0.25 cm, greater than or equal to 0.5 cm, greater than or equal to 1 cm, or greater. Combinations of these ranges are possible. For example, in some embodiments, the housing stop portion is adjacent to the external body such that a minimum distance between the housing stop portion and the external body is greater than or equal to 0 cm and less than or equal to 8 cm, or greater than or equal to 0 cm and less than or equal to 2 cm.

Although anchoring a housing stop portion to an external body may provide a number of advantages, discussed above, it has been observed in the context of this disclosure that it may, in some instances, result in a higher susceptibility of the housing stop portion to rotation and/or lateral motion. For example, anchoring the housing stop portion may be more susceptible to rotational and/or lateral motion resulting from the combination of forces originating from the stack of electrochemical cells, from the external body, and/or from other housing components. In some embodiments, the housing stop portion comprises a stabilization feature. The stabilization feature may be configured to reduce or prevent rotation and/or lateral motion of the housing stop portion. The stabilization feature may be configured to interlock and surround a portion of a fastener that passes through the solid housing component. The stabilization feature may be an integrally formed portion of the housing stop portion. For example, in some embodiments the stabilization feature is a boss (e.g., a cylindrical boss, a polyhedral boss). In some embodiments, the stabilization feature is a separate, solid body, rigidly coupled to the housing stop portion. For example, the stabilization feature may be a cylindrical or polyhedral body that is rigidly coupled to (e.g., fastened to, adhered to, or inserted into) the housing stop portion.

FIG. 15B shows stabilization features 1541 of housing stop portions 361 and 364, according to some embodiments. As shown in this particular embodiment, stabilization features 1541 are cylindrical bosses configured to pass through holes 1531 in solid housing components 314 and 316. Fasteners 1521 and 1524 can pass through stabilization features 1541 while stabilization features 1541 are within holes 1531, and can thus distribute lateral force from fasteners 1531 more uniformly in solid housing components 314 and 316.

A stabilization feature may provide any of a number of advantages, including reducing rotation of the housing stop portion, reducing wear on a solid housing component through which the fastener is configured to pass (e.g., by better distributing lateral force from the fastener into the solid housing component), and/or improving the alignment of the housing, the fastener, and/or the external body during battery assembly.

The stabilization feature may be configured to transmit force from the housing stop portion to the external body when the housing stop portion is anchored to the external body. For example, the stabilization feature may pass through a solid housing component such that, when the housing stop portion is anchored on the external body, the stabilization feature permits the transmission of force from the housing stop portion to the external body via a pathway through the stabilization feature rather than through the solid housing component. For example, referring again to FIG. 15B, stabilization features 1541 are configured such that they can directly contact an external body to which they are anchored, bypassing solid housing components 314 and 316 to permit more direct transmission of force between housing stop portions 361 and 364 and an external body.

The battery may comprise components having a potentially advantageous arrangement (e.g., for thermal management). For example, in some embodiments, a stack is described comprising electrochemical cells and lateral support components, thermally conductive solid article portions, and/or thermally insulating compressible solid article portions. The stack of electrochemical cells may be part of a battery pack (e.g., any of the battery packs described elsewhere herein). In some embodiments, a stack comprises the following in the order listed: a first electrochemical cell; a thermally conductive lateral support component; and a thermally insulating compressible solid article portion. In some embodiments, a stack comprises the following in the order listed: an electrochemical cell; a first thermally conductive lateral support component; a thermally insulating compressible solid article portion; a second thermally conductive lateral support component; and a second electrochemical cell. It should, of course, be understood that alternatives to these arrangements are also possible, including arrangements comprising additional thermally conductive solid article portions.

In some embodiments, a stack comprises the following in the order listed: a first electrochemical cell; a thermally conductive solid article portion; a thermally insulating compressible solid article portion, and a lateral support component that may or may not be thermally conducting. For example, FIG. 16 presents a cross-sectional, schematic illustration of non-limiting stack of electrochemical cells 100, which comprises housing 102 at least partially enclosing a stack comprising first electrochemical cell 110, first thermally conductive solid article portion 131, thermally insulating compressible solid article portion 140, lateral support component 150, and second electrochemical cell 120.

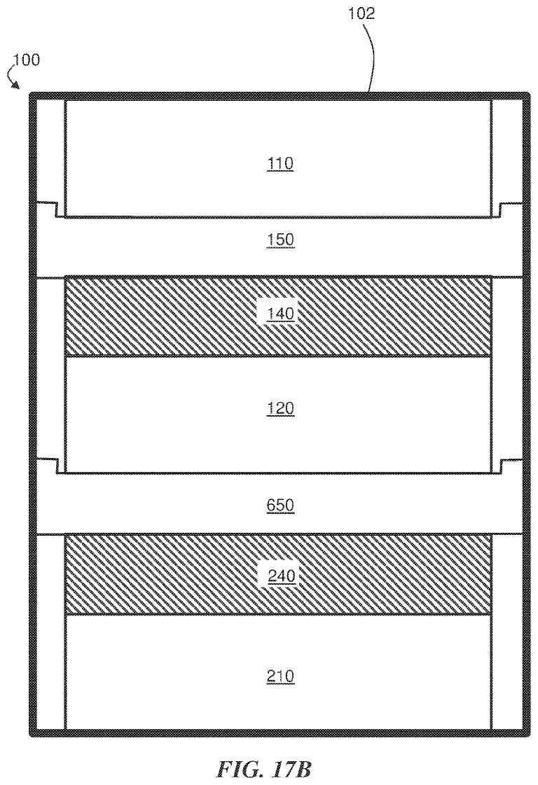

In some embodiments, a stack comprises the following in the order listed: a first electrochemical cell; a thermally conductive lateral support component; a thermally insulating compressible solid article portion, and a second electrochemical cell. For example, FIG. 17A shows a cross-sectional schematic diagram of one such embodiment, where battery 100 comprises housing 102 at least partially enclosing a stack that includes, in order: first electrochemical cell 110, thermally conductive lateral support component 150, thermally insulating compressible solid article portion 140, and second electrochemical cell 120.

In some embodiments, a stack comprises the following in the order listed: a first electrochemical cell, a first thermally conductive lateral support component, a first thermally insulating compressible solid article portion, a second electrochemical cell, a second thermally conductive lateral support component, a second thermally insulating compressible solid article portion, and a third electrochemical cell. For example, FIG. 17B shows a cross-sectional schematic diagram of one such embodiment, where battery 100 comprises housing 102 at least partially enclosing a stack that includes, in order: first electrochemical cell 110, first thermally conductive lateral support component 150, first thermally insulating compressible solid article portion 140, second electrochemical cell 120, second thermally conductive lateral support component 650, second thermally insulating compressible solid article portion 240, and third electrochemical cell 210.

In some embodiments, the lateral support component is used purely for mechanical purposes. However, in other cases, the lateral support component may fulfill more than one function, in the context of the present disclosure. For example, the lateral support component may facilitate thermal management of the battery, in some embodiments. According to some embodiments, at least a portion of the lateral support component is thermally conductive. In some embodiments, the entire lateral support component is thermally conductive. In some embodiments, at least a portion of the lateral support component is thermally insulating and compressible.

Thermally conductive portions of lateral support components may promote heat transfer away from components of the battery (e.g., away from the electrochemical cells), in some instances while also facilitating alignment of electrochemical active regions of the electrochemical cells. In some cases, the thermally conductive portion of the lateral support component is in direct contact with the electrochemical cells. For example, in FIG. 16, thermally conductive lateral support component 150 is shown as being in direct contact with second electrochemical cell 120. However, direct contact is not required, and in some embodiments, there are one or more intervening components (e.g., sensors, etc.) between thermally conductive portion of the lateral support component and the electrochemical cell.

In some embodiments, the thermally conductive portion of the lateral support component of the battery has a relatively high effective thermal conductivity. As mentioned above, such a high effective thermal conductivity may allow the thermally conductive solid article to assist with dissipating heat from one or more electrochemical cells of the battery. Thermal conductivity is generally understood to be an intrinsic property of a material related to its ability to conduct heat. Thermal conductivity is a temperature-dependent quantity and is typically reported in units of W m⁻¹ K⁻¹. The effective thermal conductivity of an article generally refers to the ability of an article to conduct heat, taking into account that the article may be made of a single material or may a non-homogeneous material that may be made of a combination of materials (e.g., a composite material such as a particulate material or layered material). The thermal conductivity or effective thermal conductivity of a thermally conductive portion of a lateral support component may be measured using a hot disk method, as described in ISO/DIS 22007-2.2.

In some embodiments, a thermally conductive portion of the lateral support component has a relatively high effective thermal conductivity in an in-plane direction. Referring again to FIG. 16, for example, first thermally conductive lateral support component 150 may have a high effective thermal conductivity in lateral direction 151, which is substantially parallel to the main portion of thermally conductive lateral support component 150. As a result, thermally conductive lateral support component 150 may enhance the rate at which heat conducted from first electrochemical cell 110 and/or second electrochemical cell 120 is then transferred away (in a lateral direction) from first electrochemical cell 110 and/or second electrochemical cell 120, according to certain embodiments. In some embodiments, the resulting accelerated rate of cooling of the electrochemical cells and/or the reduced extent of heat transfer in the thickness direction can improve the safety and/or performance of the battery (e.g., by reducing thermal propagation).

In some embodiments, a thermally conductive portion of the lateral support component has an effective thermal conductivity of greater than or equal to 10 W m⁻¹ K⁻¹, greater than or equal to 25 W m⁻¹ K⁻¹, greater than or equal to 50 W m⁻¹ K⁻¹, greater than or equal to 65 W m⁻¹ K⁻¹, greater than or equal to 80 W m⁻¹ K⁻¹, greater than or equal to 100 W m⁻¹ K⁻¹, greater than or equal to 150 W m⁻¹ K⁻¹, and/or up to 159 W m⁻¹ K⁻¹, up to 200 W m⁻¹ K⁻¹, or greater in an in-plane direction at a temperature of 25° C. For example, a thermally conductive portion of the lateral support component may be made of aluminum and have an effective thermal conductivity of 159 W m⁻¹ K⁻¹ in an in-plane direction at a temperature of 25° C.

The thermally conductive portion of the lateral support component may comprise any of a variety of suitable materials. In some embodiments, a thermally conductive portion of the lateral support component comprises a metal and/or metal alloy. Non-limiting examples of metals include, but are not limited to transition metals (e.g., titanium, manganese, iron, nickel, copper, zinc), non-transition metals (e.g., aluminum), and alloys or other combinations thereof. In certain embodiments, a thermally conductive portion of the lateral support component comprises or is made of aluminum, at least because aluminum has a relatively high effective thermal conductivity and a relatively low mass density, which in some cases contributes to an overall high specific energy density for the battery. One non-limiting type of aluminum material of which a thermally conductive portion of the lateral support component may be made is 3003 H14 series aluminum, which is aluminum alloyed with 1.2% manganese to increase strength. In some embodiments, a relatively high percentage (e.g., greater than or equal to 50 weight percent (wt %), greater than or equal to 75 wt %, greater than or equal to 90 wt %, greater than or equal to 95 wt %, greater than or equal to 99 wt %, or more) of the thermally conductive portion of the lateral support component is metal and/or metal alloy.

In some embodiments, the thermally conductive portion of the lateral support component comprises or is made of a carbon-based material. Suitable carbon-based materials include, but are not limited to, graphite, carbon-fiber, graphene (e.g., as part of thermally conductive solid article comprising a solid substrate and associated with graphene), and combinations thereof. In some embodiments, the carbon-based material is present in a relatively high percentage (e.g., greater than or equal to 50 wt %, greater than or equal to 75 wt %, greater than or equal to 90 wt %, greater than or equal to 95 wt %, greater than or equal to 99 wt %, or more) of the thermally conductive portion of the lateral support component. In some embodiments, a carbon-based material of a thermally conductive portion of the lateral support component has graphite, carbon-fiber, graphene, or a combination thereof present in an amount of at least 25 wt %, at least 50 wt %, at least 75 wt %, at least 90 wt %, at least 95 wt %, at least 99 wt %, or 100 wt %.

In some embodiments, the battery comprises a thermally conductive solid article portion (e.g., as an alternative to or in addition to thermally conductive lateral support components). Referring back to FIG. 16, battery 100 comprises thermally conductive solid article portion 131, (which is not a lateral support component because it is not configured to interface with a housing) and thermally conductive lateral support component 150. Thermally conductive solid article components may be used in addition to or as an alternative to thermally conductive lateral support components because thermally conductive solid articles may have a lower weight than thermally conductive lateral support components, while still improving a temperature distribution within the battery. Thermally conductive solid article portions may have any of the thermal properties described above with reference to thermally conductive portions of lateral support components.

The thermally conductive solid article portion may have any of a variety of form factors. In some embodiments, the thermally conductive solid article portion is in the form of a relatively planar object (notwithstanding the non-planarities and/or alignment features). For example, the thermally conductive solid article portion (may be in the form of a main solid body (e.g., a metal and/or metal alloy sheet). In some embodiments, the thermally conductive solid article portion is or comprises a fin (e.g., a metal and/or metal alloy fin). In some embodiments, the thermally conductive solid article portion is or comprises a sheet. It should be understood that the surfaces of a thermally conductive solid article portion do not necessarily need to be flat. For example, one of the sides of a thermally conductive solid article portion could have any of the non-planarities and/or alignment features described herein.

The thermally conductive solid article portion may have a thickness as well as two orthogonal lateral dimensions that are perpendicular to each other as well as perpendicular to the thickness. For example, referring to FIG. 16, first thermally conductive solid article portion 131 has maximum thickness 235, lateral dimension 151, and a second lateral dimension (not pictured) perpendicular to both maximum thickness 235 and lateral dimension 151 (which would run into and out of the plane of the drawing in FIG. 16). In some embodiments, the thermally conductive solid article portion has at least one lateral dimension that is at least 5 times, at least 10 times, and/or up to 20 times, up to 50 times, up to 100 times or more greater than the maximum thickness of the thermally conductive solid article portion.

In certain aspects, batteries with components that may facilitate alignment of electrochemical active areas are generally described. Alignment of battery components may be particularly important when batteries comprise lateral support components. For example, proper alignment of the battery component may advantageously help to secure an electrochemical cell to a lateral support component, such that the lateral support components can inhibit lateral motion of the electrochemical cells. For example, the electrochemical cell may be held in place by alignment features, as described below. The alignment may be configured to provide frictional forces to inhibit lateral motion of the electrochemical cell, in some embodiments. Alignment of the battery components may increase the frictional force and/or the force that the alignment features are able to transmit to prevent lateral motion of the electrochemical cell.

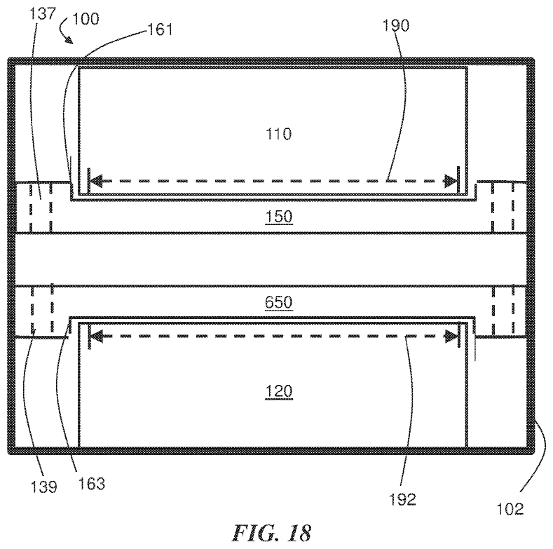

In some embodiments, a lateral support component or thermally conductive solid article portion component comprises an alignment feature. An alignment feature may be, for example, a structural component of the lateral support component (or the thermally conductive solid article portion) that can assist with the positioning of the lateral support component with respect to another component of the battery. In FIG. 18, first lateral support component 150 comprises first alignment feature 137 and second lateral support component 650 comprises second alignment feature 139, according to some embodiments. In some instances, first alignment feature 137 and second alignment feature 139 can be used to fix the relative positions of first lateral support component 150 and second lateral support component 650 with respect to each other.

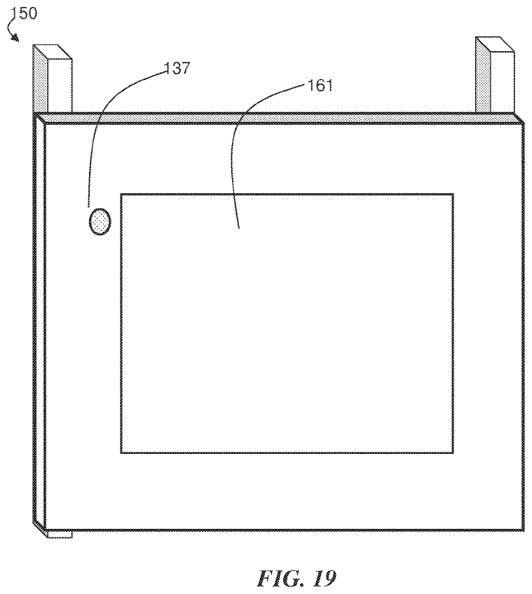

An alignment feature may take any of a variety of suitable structural forms. For example, in some embodiments, an alignment feature of a battery component (e.g., a lateral support component) is a gap in the battery component. FIG. 18 shows one such example, where first alignment feature 137 and second alignment feature 139 are gaps in first lateral support component 150 and second lateral support component 650, respectively. FIG. 19 shows a perspective view of first alignment feature 137 as a gap in lateral support component 150, according to some embodiments. In certain cases, a gap serving as an alignment feature may be a through-hole, slot, or opening in a lateral support component or thermally conductive solid article portion. In some embodiments, an alignment feature is a protrusion of the lateral support component or thermally conductive solid article portion. Alignment features of battery components may be substantially similar or the same (e.g., both gaps, both edges, both protrusions). However, in some instances an alignment feature of battery components are different (e.g., a first alignment feature is a gap and a second alignment feature is a protrusion).

One non-limiting way in which alignment features may be substantially aligned when the alignment features are gaps is by passing an object through the alignment features (e.g., through the first alignment feature and the second alignment feature). Non-limiting examples of objects that may be passed through the alignment features include, but are not limited to rods, rivets, fasteners, bands, wires, and straps. Another non-limiting way in which alignment features may be substantially aligned is by visual or optical inspection (e.g., to see if electromagnetic radiation can pass through the alignment features).

Aligning components of the battery with the housing may prove advantageous to some embodiments by facilitating a reduction in the number of constituent parts of the housing, reducing a largest lateral pressure applying dimension of the housing, and/or increasing the battery's volumetric energy density. Aligning components of the battery may be particularly important for batteries comprising lateral support components, since the lateral support components may be configured to be flush with or to interface with the housing, allowing a relatively low tolerance for misalignment of components.

It should be understood that the battery may not be limited to two electrochemical cells, and may comprise at least 2, at least 3, at least 4 at least 5, at least 8, at least 10, and/or up to 12, up to 15, up to 20, up to 24, up to 30, up to 40, up to 48, or more electrochemical cells. In some such cases, the total number of thermally insulating compressible solid article portions is equal to one more than the total number of electrochemical cells in the battery (e.g., 12 electrochemical cells and 13 thermally insulating compressible solid article portions). For example, there may be an electrochemical cell between each of the thermally insulating compressible solid article portions.

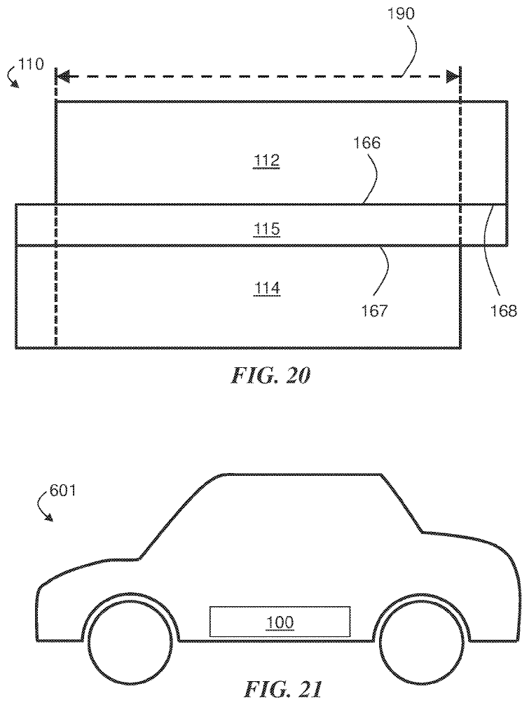

Each of the electrochemical cells in the batteries described herein may have an electrochemical active region. For example, FIG. 18 shows an embodiment where battery 100 comprises first electrochemical cell 110 comprising first electrochemical active region 190 and second electrochemical cell 120 comprising second electrochemical active region 192. An electrochemical active region refers to a region defined by the overlap of the electrode surfaces that contain active material of the anodes and electrode surfaces that contain active material of the cathodes of the electrochemical cell. For example, referring to FIG. 20, first electrochemical cell 110 has electrochemical active region 190 defined by the overlap of anode electrode surface 166 of the anode (which contains anode active material) and electrode surface 167 of the cathode (which contains cathode active material). In some embodiments, a portion of an anode and/or cathode may not be part of the electrochemical active region of the electrochemical cell. For example, an anode and cathode may be offset such that a portion of an anode comprising the anode active material does not overlap with the corresponding cathode portion that contains cathode active material, thereby preventing that portion of the anode from participating in electrochemical reactions with the cathode. Referring to FIG. 20, portion 168 of anode 112 does not overlap with any of cathode 114 and therefore cannot participate in any electrochemical reactions with cathode 114, and therefore portion 118 of anode 112 is not part of first electrochemical active region 190, according to certain embodiments.

A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium (e.g., lithium metal and/or a lithium metal alloy) during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li₄Ti₅O₁₂, also referred to as “LTO”), tin-cobalt oxide, or any combinations thereof.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. Further details of potentially suitable cathode materials are described, for example, in U.S. Patent Publication No. 2021/0151839 A1, published on May 20, 2021, and entitled, “BATTERIES, AND ASSOCIATED SYSTEMS AND METHODS,” which is incorporated herein by reference in its entirety for all purposes.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and one or more components of the electrolyte, thereby suppressing side reactions.

Any of a variety of materials can be used as an electrolyte, in embodiments in which an electrolyte is present. The electrolyte can comprise, for example, a solution of ions, a solid electrolyte, a gel electrolyte, and/or a combination of these.

In some embodiments, the electrochemical cells of the battery further comprise a separator between two electrode portions (e.g., an anode portion and a cathode portion). The separator may be a solid non-conductive or insulative material, which separates or insulates the anode and the cathode from each other preventing short circuiting, and which permits the transport of ions between the anode and the cathode. In some embodiments, the porous separator may be permeable to the electrolyte. Solid electrolytes and gel electrolytes may also function as a separator in addition to their electrolyte function.

The electrochemical cell (e.g., the first electrochemical cell and/or second electrochemical cell) may be configured such that the housing does not restrict motion of the lateral support component in a direction substantially parallel to the component of the anisotropic force. For example, the electrochemical cell may be positioned such that it is disconnected from the housing and/or is capable of motion within the housing or along a track of the housing, like the lateral support component. This may allow the electrochemical cell to transmit anisotropic force through the stack of electrochemical cells. This may, advantageously, improve the spatial uniformity of force within the battery. Alternatively, in some embodiments, the lateral support component is configured to be flush with the housing, such that a track is not required.

In some aspects, batteries comprising solid articles that can compensate for dimensional changes of other battery components while also limiting heat transfer between electrochemical cells are generally described. FIGS. 17A-17B are schematic diagrams of non-limiting embodiments of battery 100. Battery 100 in FIGS. 17A-17B comprise first electrochemical cell 110 and second electrochemical cell 120 as part of a stack with thermally insulating compressible solid article portion 140. In some, but not necessarily all cases, the thermally insulating compressible solid article portion is in direct contact with the first electrochemical cell and/or the second electrochemical cell. For example, in FIG. 17A, thermally insulating compressible solid article portion 140 is shown as being in direct contact with both first electrochemical cell 110 and second electrochemical cell 120. However, direct contact is not required, and in some embodiments, there are one or more intervening components (e.g., other solid article portions such as plates, sheets, fins, sensors, etc.) between the thermally insulating compressible solid article portion and the first electrochemical cell and/or second electrochemical cell.

The thermally insulating compressible solid article portion may take any of a variety of forms. For example, the thermally insulating compressible solid article portion may be in the form of a solid block, a foam sheet, a mesh, or any other suitable form, provided that it be thermally insulating and compressible. It should be understood that although the thermally insulating compressible solid article portion is referred to as a solid article, it may be at least partially hollow and/or contain pores or voids.

In some embodiments, the thermally insulating compressible solid article portion is a unitary object. FIG. 17A depicts thermally insulating compressible solid article portion 140 as a unitary object (e.g., a single sheet of foam), as one example. It should be understood that a thermally insulating compressible solid article portion that is a unitary object may be part of a larger article in some instances. In some embodiments, the thermally insulating compressible solid article portion comprises multiple separate objects. For example, the thermally insulating compressible solid article portion may comprise multiple layers (e.g., sheets) of either the same or different materials (e.g., foams) as a stack or otherwise arranged. In instances where the thermally insulating compressible solid article portion comprises multiple separate objects (e.g., a stack of foam sheets), the parameters of the thermally insulating compressible solid article portion correspond to that of the aggregate of all the separate objects of that portion (e.g., all foam sheets measured together as a stack).

In some embodiments, the thermally insulating compressible solid article portion comprises a foam. A foam solid article generally refers to a solid containing pockets of “cells” capable of being occupied by a fluid. The foam may be open-cell (in which cells are connected to each other, thereby allowing for fluid transport between them) or closed-cell. The pockets may be present throughout the dimensions of the solid. The foam may be present as a relatively high percentage of the thermally insulating compressible solid article portion (e.g., greater than or equal to 50 weight percent (wt %), greater than or equal to 75 wt %, greater than or equal to 90 wt %, greater than or equal to 95 wt %, greater than or equal to 99 wt %, or more).

In some embodiments, thermally insulating compressible solid article portion 140 comprises a microcellular foam. A microcellular foam generally refers to a foam whose cells have an average largest cross-sectional dimension on the order of microns (e.g., greater than or equal to 0.1 micron, greater than or equal to 1 micron, and/or up to 50 microns, up to 100 microns, or up to 500 microns).

In some embodiments, the thermally insulating compressible solid article portion comprises a mesh. As an example, in certain instances, the thermally insulating compressible solid article portion is a mesh structure made of strands of flexible, thermally-insulating material (e.g., fiber, plastic) that are attached and/or woven together.

In some embodiments, the thermally insulating compressible solid article portion has a relatively low effective thermal conductivity in the thickness direction. Referring again to FIG. 17A, for example, thermally insulating compressible solid article portion 140 may have a low effective thermal conductivity in thickness direction 143. As a result, thermally insulating compressible solid article portion 140 may reduce the rate at which heat is transferred from first electrochemical cell 110, through thermally insulating compressible solid article portion 140 in thickness direction 143, and to second electrochemical cell 120, according to certain embodiments. This reduced extent of heat transfer in the thickness direction can, in some instances, improve the safety and performance of the battery (e.g., by reducing thermal propagation). In some embodiments, the thermally insulating compressible solid article portion has an effective thermal conductivity of less than or equal to 0.5 W m⁻¹ K⁻¹, less than or equal to 0.25 W m⁻¹ K⁻¹, and/or as low as 0.1 W m⁻¹ K⁻¹, as low as 0.01 W m⁻¹ K⁻¹, or less in the thickness direction at a temperature of 25° C. For example, the thermally insulating compressible solid article portion may comprise a microcellular foam and have an effective thermal conductivity of 0.21 W m⁻¹ K⁻¹ in the thickness direction at a temperature of 25° C. In some embodiments, the rate of heat transfer between two components of the battery (e.g., first electrochemical cell 110 and second electrochemical cell 120 in FIG. 17A) is relatively low. In certain cases, the rate of heat transfer from the first electrochemical cell to the second electrochemical cell is less than or equal to 5 W ml K⁻¹, less than or equal to 2.5 W m⁻¹ K⁻¹, and/or as low as 1 W m⁻¹ K⁻¹, as low as 0.1 W m⁻¹ K⁻¹, or less when the temperature difference between the first electrochemical cell and the second electrochemical cell is 10 K.

The compressibility of the thermally insulating compressible solid article portion may be useful in any of a variety of applications. As one example, in some instances in which one or more components of the battery change dimension during a charging and/or discharge process, a resulting compression of the thermally insulating compressible solid article portion may compensate for that change in dimension. In some such cases, the compressibility of the thermally insulating compressible solid article portion under stress may reduce the extent to which a battery expands or contracts when electrochemical cells within the battery undergo expansion and/or contraction during cycling.

The thermally insulating compressible solid article portion can be made of any of a variety of suitable materials, provided that it has one or more of the combinations of thermal and mechanical properties in the present disclosure. In some embodiments, the thermally insulating compressible solid article portion comprises a polymeric material. A relatively large percentage of the thermally insulating compressible solid article portion may be made of a polymeric material. For example, greater than or equal to 50 wt %, greater than or equal to 75 wt %, greater than or equal to 90 wt %, greater than or equal to 95 wt %, greater than or equal to 99 wt %, or more (e.g., 100 wt %) of the thermally insulating compressible solid article portion may be made of a polymeric material. In certain embodiments, the thermally insulating compressible solid article portion comprises a polymeric foam, such as a microcellular polymeric foam.

While any of a variety of polymeric materials may be suitable, in certain instances the thermally insulating compressible solid article portion comprises a relatively elastic polymer. In some embodiments, the thermally insulating compressible solid article portion is or comprises an elastomer. As one non-limiting example, the thermally insulating compressible solid article portion may comprise a polyurethane. Polyurethanes are polymers comprising organic repeat units linked by carbamate (urethane) units. Polyurethanes can be made using any of a variety of techniques, such as by reacting isocyanates and polyols. In some embodiments, the thermally insulating compressible solid article portion is or comprises a microcellular polyurethane foam (e.g., foam sheet or foam layer). Referring to FIG. 17A, for example, battery 100 may comprise first electrochemical cell 110, second electrochemical cell 120, and thermally insulating compressible solid article portion 140 between first electrochemical cell 110 and second electrochemical cell 120, where thermally insulating compressible solid article portion 140 is an elastomeric microcellular foam layer or sheet made of polyurethane. One non-limiting example of an elastomeric microcellular polyurethane foam that can be used as a thermally insulating compressible solid article portion is sold by BASF under the trade name Cellasto®.

In some embodiments, the first thermally insulating compressible solid article portion and the second thermally insulating compressible solid article portion are part of discrete articles. Referring again to FIG. 17B, for example, in some embodiments first thermally insulating compressible solid article portion 140 and second thermally insulating compressible solid article portion 240 are separate, discrete articles (e.g., separate foam sheets). However, in some embodiments, the first thermally insulating compressible solid article portion and the second thermally insulating compressible solid article portion are part of the same article. For example, first thermally insulating compressible solid article portion 140 and second thermally insulating compressible solid article portion 240 may be connected via a third thermally insulating compressible solid article portion hidden behind second electrochemical cell 120 in FIG. 17B. As one example, the battery may comprise a thermally insulating compressible solid article that is foldable and/or has a serpentine shape such that electrochemical cells and/or other components of the battery can be arranged between portions of the thermally insulating compressible solid article portion.

The lateral support component can comprise a thermally insulating and compressible material as described herein such that it can act as a thermally insulating compressible solid article portion, according to some embodiments. However, the lateral support component is not always thermally insulating or compressible.

In some embodiments, the electrochemical cells and batteries (e.g., rechargeable batteries) described in this disclosure can be used to provide power to an electric vehicle or otherwise be incorporated into an electric vehicle. As a non-limiting example, stacks of electrochemical cells and/or batteries described in this disclosure (e.g., comprising lithium metal and/or lithium alloy electrochemical cells) can, in certain embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle. FIG. 21 shows a cross-sectional schematic diagram of electric vehicle 601 in the form of an automobile comprising battery 100, in accordance with some embodiments. Battery 100 can, in some instances, provide power to a drive train of electric vehicle 601.

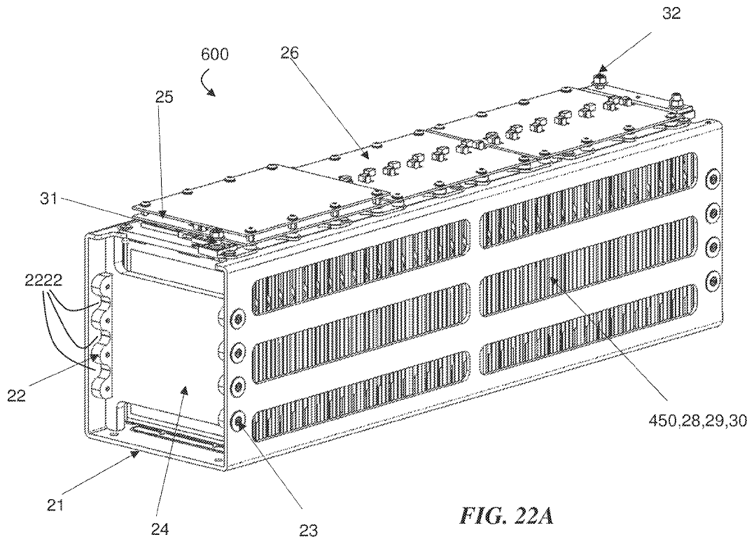

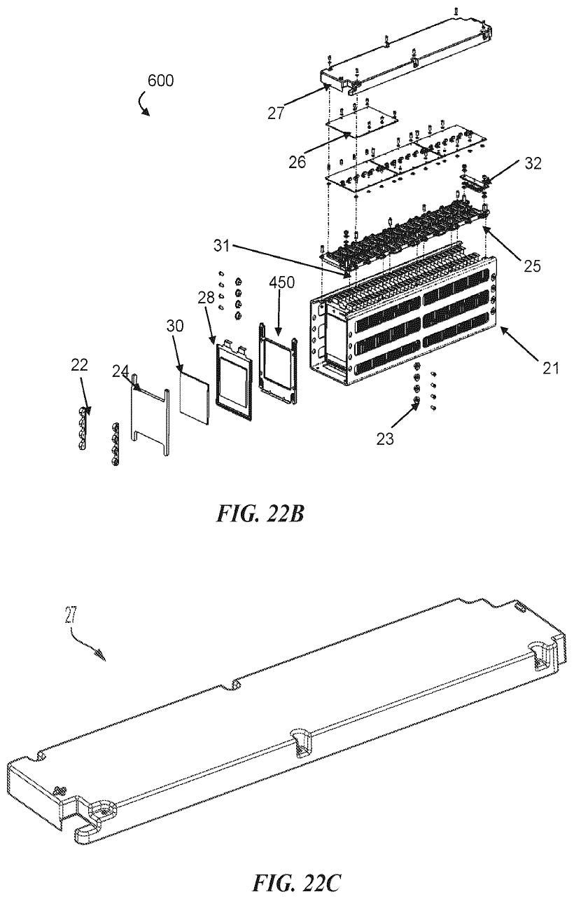

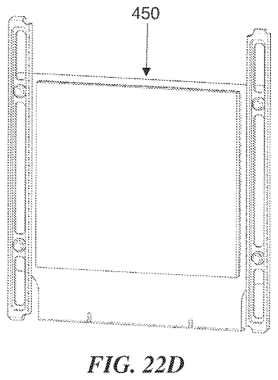

FIGS. 22A-22D show perspective view schematic illustrations of battery pack 600, also shown in FIG. 13, and components thereof, according to some embodiments. Battery pack 600 shown in FIGS. 13 and 22A-22D comprises a plurality of electrochemical cells arranged in stack 610. FIG. 13 shows battery pack 600 with cover 27 present, while FIG. 22A shows battery pack 600 without cover 27 to show other components of battery pack 600 more clearly. As can be seen in FIG. 22A and in FIG. 22B (an exploded perspective view schematic illustration of battery pack 600), battery pack 600 comprises a housing comprising a solid housing component in the form of carbon fiber composite frame 21, titanium alloy stop portions 22 having spaces 2222, titanium alloy inserts 23, carbon fiber composite solid plate 24, lateral support component 450 (which is also a thermally conducting solid article portion), polymeric substrate 25, circuit board 26, electrochemical cells 28, thermally insulating compressible solid article portions 30, positive terminal 31, and negative terminal 32. Tabs of electrochemical cells 28 are electronically coupled to positive terminal 31 and negative terminal 32 via metallic electronically conductive interconnects attached to substrate 25. Stop portions 22 are coupled to frame 21 via inserts 23 (which pass through holes in frame 21) via fasteners. In some embodiments, frame 21 has a length of 490 mm and a width of 130.5 mm. FIG. 22C shows a perspective view schematic illustration of cover 27. FIG. 22D shows a perspective view schematic illustration of lateral support component 450, described more fully with reference to FIG. 8, above.

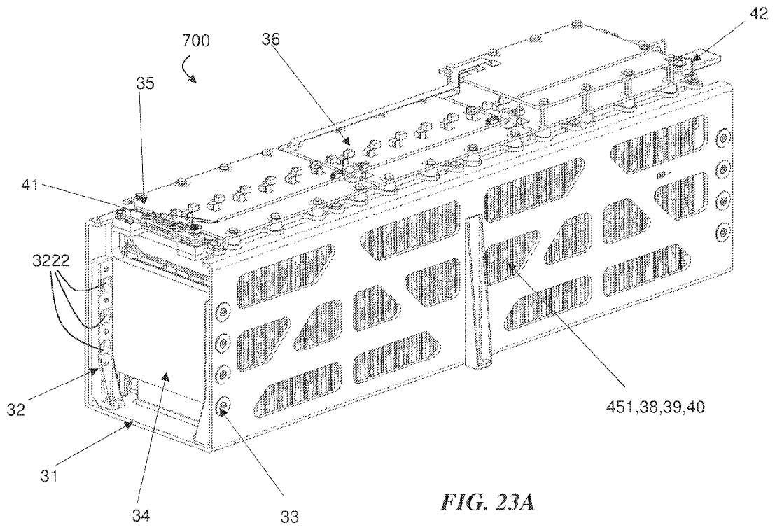

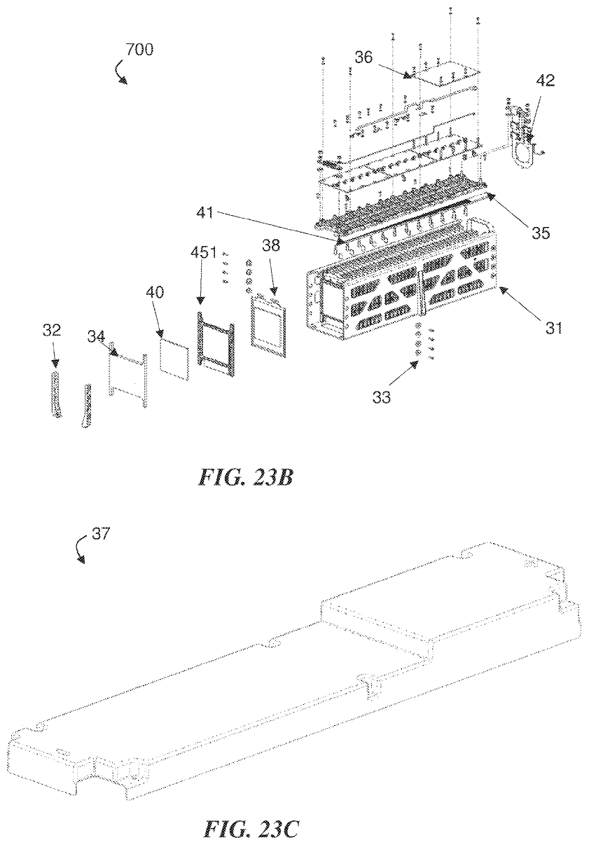

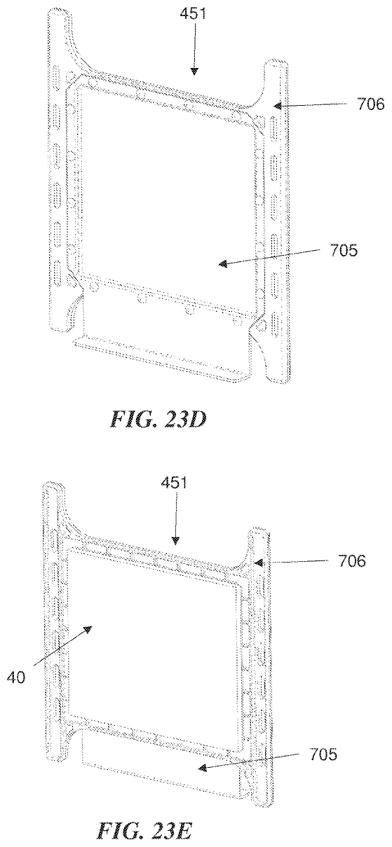

FIGS. 23A-23D show perspective view schematic illustrations of battery pack 700, which is example of an embodiment of a battery pack having stop portions configured to be anchored to an external body. FIG. 23A shows battery pack 700 without cover 37 to show other components of battery pack 700 more clearly. As can be seen in FIG. 23A and in FIG. 23B (an exploded perspective view schematic illustration of battery pack 700), battery pack 700 comprises a housing comprising a solid housing component in the form of carbon fiber composite frame 31, titanium alloy stop portions 32 having spaces 3222, titanium alloy inserts 33, carbon fiber composite solid plate 34, lateral support component 451 (which is also a thermally conducting solid article portion), polymeric substrate 35, circuit board 36, electrochemical cells 38, thermally insulating compressible solid article portions 40, positive terminal 41, and negative terminal 42. Tabs of electrochemical cells 38 are electronically coupled to positive terminal 41 and negative terminal 42 via metallic electronically conductive interconnects attached to substrate 35. Stop portions 32 are coupled to frame 31 via inserts 33 (which pass through holes in frame 31) via fasteners. Stop portions 32 are configured to be anchored to an external body (e.g., by extending to the bottom of frame 31 and providing an opening through which at least a portion of a fastener can pass). In some embodiments, frame 31 has a length of 490 mm and a width of 130.5 mm. FIG. 23C shows a perspective view schematic illustration of cover 37. FIG. 23D shows a front perspective view schematic illustration of lateral support component 451, which comprises main solid body 705 in the form of a copper plate and solid body 706 with lateral bracing in the form of plastic buckle bars. FIG. 23E shows a back perspective view schematic illustration of lateral support component 451 in contact with thermally insulating compressible solid article portion 40 in the form of a compressible foam (e.g., a microcellular polyurethan foam sheet).

In some instances, frame 21, stop portions 22, inserts 23, and/or solid plate 24 are configured to apply an anisotropic force with a component perpendicular to an electrode surface of electrochemical cells 28 of stack 610 during at least a portion of a charging or discharging process of battery pack 600. Such an anisotropic force may define a pressure of at least 3 kg_{f}/cm² at state of charge of 0% for at least some or all of the cells and of at least 12 kg_{f}/cm² (such as up to 15 kg_{f}/cm², up to 25 kg_{f}/cm², or higher) at a stage of charge of 100% for at least some or all of the cells in stack 610. In some embodiments, a first subset of electrochemical cells 28 are part of a first battery module within battery pack 600 (e.g., where the electrochemical cells are coupled in series to a first pair of terminals comprising a positive terminal and a negative terminal), and a second subset of electrochemical cells 28 are part of a second battery module within battery pack 600 (e.g., where the electrochemical cells are coupled in series to a second pair of terminals comprising a positive terminal and a negative terminal, not shown). The first battery module and second battery module within battery pack 600 may be charged and/or discharged independently (e.g., with or without multiplexing), in some instances at different rates.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21, 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18, 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. Application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. Application Ser. No. 14/848,659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. Application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; and U.S. application Ser. No. 17/702,971, filed Mar. 24, 2022, and entitled, “BATTERY PACK AND RELATED COMPONENTS AND METHODS”.

U.S. Provisional Patent Application No. 63/328,091, filed Apr. 6, 2022, and entitled “LATERAL CONSTRAINT OF BATTERY COMPONENTS UNDER FORCE,” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of.” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A battery, comprising:
a housing at least partially enclosing:
a first electrochemical cell;
a second electrochemical cell; and
a lateral support component;
wherein:
the housing is configured to apply, during at least one period of time during charge and/or discharge of the first electrochemical cell and/or the second electrochemical cell, an anisotropic force with a component perpendicular to an electrode surface of the first electrochemical cell and/or an electrode surface of the second electrochemical cell, and
the lateral support component is configured to inhibit motion of the first electrochemical cell and/or the second electrochemical cell in at least one direction having a component perpendicular to the component of the anisotropic force.

2. A battery as in claim 1, wherein the lateral support component is configured to inhibit motion of the first electrochemical cell and/or the second electrochemical cell in any direction that is not substantially parallel to the component of the anisotropic force perpendicular to the electrode surface of the first electrochemical cell and/or the electrode surface of the second electrochemical cell.

3. A battery as in claim 1, wherein the battery is configured such that the housing does not restrict motion of the first electrochemical cell or the second electrochemical cell in a direction substantially parallel to the component of the anisotropic force perpendicular to the electrode surface of the first electrochemical cell and/or the electrode surface of the second electrochemical cell.

4. A battery, comprising:
a housing at least partially enclosing:
a first electrochemical cell;
a second electrochemical cell; and
a lateral support component;
wherein the lateral support component comprises a support feature that contacts the housing and is configured to inhibit lateral motion of the first electrochemical cell and/or the second electrochemical cell.

5. A battery as in claim 4, wherein the housing is configured to apply, during at least one period of time during charge and/or discharge of the first electrochemical cell and/or the second electrochemical cell, an anisotropic force with a component perpendicular to an electrode surface of the first electrochemical cell and/or an electrode surface of the second electrochemical cell.

6. A battery as in claim 1, wherein the component of the anisotropic force perpendicular to the electrode surface of the first electrochemical cell and/or the electrode surface of the second electrochemical cell defines a pressure of at least 3 kg_{f}/cm².

7. A battery as in claim 1, wherein the lateral support component inhibits motion of the first electrochemical cell and/or the second electrochemical cell via interaction with the housing.

8. A battery as in claim 1, wherein an aspect ratio of the battery is greater than or equal to 1.

9. A battery as in claim 1, wherein the lateral support component creates a cavity within the housing.

10. A battery as in claim 1, wherein the lateral support component is configured to be flush with the housing.

11. A battery as in claim 1, wherein the lateral support component comprises a main solid body and lateral bracing.

12. A battery as in claim 11, wherein the lateral bracing comprises a bar, a ridge, a crimp, a fold, or a raised portion of the lateral support component.

13. A battery as in claim 12, wherein the lateral bracing comprises integrally formed, raised portions of the lateral support component.

14. A battery as in claim 12, wherein the lateral bracing comprises two bars substantially parallel to one another and located at opposing edges of the lateral support component.

15. A battery as in claim 1, wherein the lateral support component comprises a thermally conductive solid article portion.

16. A battery as in claim 1, wherein the lateral bracing is configured to inhibit bending of the lateral support component during application of the anisotropic force

17-21. (canceled)

22. A vehicle comprising a battery as in claim 1.

23. A battery as in claim 1, wherein the electrode surface is an electrode active surface.

24. A method, comprising:
applying, during at least one period of time during charge and/or discharge of the battery of claim 1, the anisotropic force with a component perpendicular to the electrode surface of the first electrochemical cell and/or the electrode surface of the second electrochemical cell.

25-27. (canceled)

28. A battery, comprising:
a first electrochemical cell;
a second electrochemical cell;
a housing comprising a solid plate, a housing stop portion adjacent to an exterior surface of the solid plate, and a solid housing component;
wherein:
the housing at least partially encloses the first electrochemical cell and the second electrochemical cell
the solid plate is configured to apply, during at least one period of time during charge and/or discharge of the first electrochemical cell and/or the second electrochemical cell, an anisotropic force with a component perpendicular to an electrode surface of the first electrochemical cell and/or an electrode surface of the second electrochemical cell;
the solid housing component is coupled to the solid plate via coupling to the housing stop portion; and
the housing stop portion is configured to be anchored to a body external to the battery via a fastener.

29-41. (canceled)
